(19) United States
(12) Patent Application Publication
(10) Pub. No.: US 2013/0197967 A1
(43) Pub. Date: Aug. 1, 2013

(54) COLLABORATIVE SYSTEMS, DEVICES, AND PROCESSES FOR PERFORMING ORGANIZATIONAL PROJECTS, PILOT PROJECTS AND ANALYZING NEW TECHNOLOGY ADOPTION

(71) Applicants: James Joseph Anthony PINTO, Richmond (CA); Michael SOLOVYOV, Vancouver (CA)

(72) Inventors: James Joseph Anthony PINTO, Richmond (CA); Michael SOLOVYOV, Vancouver (CA)

(21) Appl. No.: 13/756,686

(22) Filed: Feb. 1, 2013

Related U.S. Application Data
(60) Provisional application No. 61/593,514, filed on Feb. 1, 2012.

(51) Int. Cl. G06Q 10/06

(52) U.S. Cl. CPC G06Q 10/0637
USPC 705/7.28; 705/7.36

(57) ABSTRACT

Processes, machines, and computer-readable media are provided for proposing and evaluating pilot projects. A project management system stores feedback items specified by agents of an organizational entity in association with a pilot project. An agent may submit a feedback item in association with a type of feedback such as: problem reporting feedback, action recommending feedback, question asking feedback, feature recommending feedback, or feature listing feedback. The project management system causes display, to an agent on a type-selection interface, of two or more options, each corresponding to a different type of feedback on the pilot project. The project management system receives a selection of an option to view or create feedback items of a type. In response, the project management system causes display of feedback items of the particular type and an option to create a feedback item of the particular type.

### CROSS REFERENCE

The present application claims priority from U.S. Patent Application No. 61/593,514 filed Feb. 1, 2012, which is hereby incorporated herein by reference

### TECHNICAL FIELD

The present application relates to computers, and more particularly, to collaborative systems, devices, and processes for performing organizational projects, pilot projects and analyzing new technology adoption.

### BACKGROUND

An organizational entity, such as a corporation, a department, or other business or workplace entity, often participates in projects for evaluation by a group of agents of the organizational entity. Various forms of technologies and new initiatives that form the backbone of organizational entities may initially be tested as pilot projects in the organizations. Example technologies may include, but are not limited to, new phone systems, new laptop computers, new network devices, new tablet computers, new at-home networks or virtual private networks, and new cloud-based applications. New initiatives may involve a new geographical setting for an office, a new type of corporate event or a new corporate policy.

Pilot projects are often assigned to a group of employees using a top-down approach. For example, a pilot project may be started by a manager, communicated to employees in a department, and practiced by the employees in the department. The manager may personally evaluate the pilot project by physically interacting with employees or by otherwise communicating directly with the employees. Such a system relies on direct communication between the manager and the employees, and often hinges on the ability of the manager to recognize positive and negative components of the pilot project, and components of the pilot project that need more resources, assistance by the Information Technology (IT) department, brainstorming or problem-solving attention, or other managerial oversight. Moreover, personal evaluation by a manager does not encourage employees to provide feedback on pilot projects. In fact, many employees avoid providing feedback on pilot projects to their manager out of fear that their manager may react negatively to such feedback. As a result, sometimes employees circumvent their managers by making the suggestions to other managers. Worse, many employees keep these suggestions to themselves, regardless of whether the suggestions would result in more efficient or productive participation in the pilot project by the employees. Further, multiple users often have similar questions, problems to report, or general feedback to share with IT or central managers. When each employee calls the IT person or manager with the same problem, resources are inefficiently wasted as managers and IT representatives are distracted dealing with the same issue over and over again and end users are often left waiting in response queues and distracted from their work. This problem is particularly evident in organizations with hundreds or thousands of employees.

Cost is also a concern. Organizations often adopt a technology without conducting a proper pilot project. In one example, discussed by Chris Edwards in Government Cost Overruns (http://www.downsizinggovernment.org/government-cost-overruns) the Department of Veterans Affairs wasted $265 million on a computer upgrade project that was never completed. The city of Portland, Oreg., in 2010, found a rollout of SAP's ERP applications mishandled, with the project running three times over budget, taking more than double the time to deploy and lacking promised functionality, according to city auditors (http://www.informationweek.com/news/government/state-local/228200542). According to the article, “The city's planned financial and HR system has cost $47.4 million so far, instead of the planned $14.2 million, and still lacks promised functionality, auditors say”. Moreover, improperly conducted projects, particularly those related to technology, may not actually meet the needs of their users or may be obsolete before they are completed.

In other cases, employees may introduce into the corporate environment or experiment with new technology in their personal capacities without managerial oversight, in what is commonly being referred to as “Rogue IT”. In these cases, where distinct employees are simultaneously experimenting with new technology, neither the overall organization, nor other similarly situated employees, benefit from the experiences of the individuals experimenting with the new technology and the individual does not benefit from IT expertise or insights and suggestions from colleagues.

Managers may connect with their employees in social networking environments such as on LinkedIn™, on Facebook™, or on Google Plus™. Social networking environments allow users to post content and send messages to each other. The social networking environments promote conversation among the users in the public sphere, but they do not promote efficient or productive participation in pilot projects by employees.

Organizational entities do not have tools to efficiently propose and evaluate pilot projects.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section. It is an object of the following to obviate or mitigate at least one of the foregoing issues.

### BRIEF DESCRIPTION OF THE DRAWINGS

In the drawings:

FIG. 1 illustrates an example process for creating different types of feedback items.

FIG. 2 illustrates an example process for rating a feedback item.

FIG. 3 illustrates an example interface that displays options to create or view existing feedback items.

FIG. 4 illustrates an example interface for creating a feedback item.

FIG. 5 illustrates an example interface for browsing, searching, and/or filtering feedback items, including an option to create a new feedback item.

FIG. 6 illustrates an example interface for rating a feedback item.

FIG. 7 illustrates an example process for inviting others to provide feedback item input.

FIG. 8 illustrates an example process for combining feedback items into a collection of feedback items.

FIG. 9 illustrates an example process for managing input with respect to a hierarchy of feedback items.

FIG. 10 illustrates an example process for receiving user feedback with respect to an individual element of a feedback item.

FIG. 11 illustrates an example process for analyzing metrics based on user feedback.

FIG. 12 illustrates an example process for notifying agents about updates to feedback items.

FIG. 13 illustrates an example process for preserving anonymity for feedback item content.

FIG. 14 illustrates an example process for managing certification of feedback items.

FIG. 15 illustrates an example process for selling feedback items.

FIG. 16 illustrates an example computer system on which various embodiments may be implemented.

FIG. 17 illustrates an example process for creating a project for evaluation by a group of agents.

FIGS. 18A-B illustrate an example of a pilot project.

FIG. 19 illustrates an example process for performing a pilot project.

### DETAILED DESCRIPTION

In the following description, for the purposes of explanation, numerous specific details are set forth in order to provide a thorough understanding of the systems, devices and processes described herein. It will be apparent, however, that the systems, devices and processes described herein may be practiced without these specific details. In other instances, well-known structures and devices are shown in block diagram form in order to avoid unnecessarily obscuring the systems, devices and processes described herein.

### General Overview

Collaborative project management systems, devices, and processes are provided for proposing and evaluating pilot projects. The techniques described herein feature one or more computer processes, non-transitory computer-readable media, and/or special-purpose computing devices for storing feedback items specified by agents of an organizational entity in association with specified types of feedback, and providing options for an agent to view, modify, create, or rate different types of feedback items. In various embodiments, the systems, devices, and processes described herein may enable agents of an organizational entity to evaluate the merits and demerits of a tool, problem, feature, task or the like that is the topic of an organizational or pilot project. The systems, devices, and processes described herein may also build collaboration and knowledge sharing specifically tailored to an organizational or pilot project scenario and the particular problems organizations may have in collecting feedback and fostering better decision making about the tool, problem, feature, or task that is the topic of the project. Agents using any of the systems, devices, and processes described herein may develop organizational practices and processes. The systems, devices, and processes described herein may generate supporting documentation for organizational practices and processes in pursuit of the goals of the organizational entity. Features and aspects described herein in terms of a system or device can also be realized by a process. Likewise, features and aspects described herein in terms of a process can also be realized by a system or device.

Various organizational projects face differing constraints. Pilot projects, for example, have different requirements from other kinds of organizational projects that an organization may undertake. Pilot projects can be short in duration when compared to other projects. Pilot projects can also be different in that only a small subset of the organization, such as test group, may be involved. A pilot project may have a clearly defined ending, after which an assessment of success or failure is made to determine whether the larger organization can benefit from the subject of the pilot project. Other characteristics of pilot projects that differentiate them from other kinds of organizational projects include: a wider variety of participants rather than concentration among specific departments, an informal nature, higher potential for uncertainty and project failure risk than other types of projects, and a need to bypass, if only temporarily, established organizational structures. For the purposes of this disclosure, pilot projects may also include recent technological systems and devices adopted by the organizations, even if a preliminary evaluation period has been concluded. Organizations may continue to evaluate and provide feedback items in respect of such systems and devices using the techniques described herein. Other differences between pilot projects and other kinds of projects may become apparent to one of ordinary skill in the art upon reading this disclosure.

In one embodiment, the project management system stores feedback items specified by agents of an organizational entity in association with an organizational or pilot project. An agent may submit a feedback item in association with a specified type of feedback. For example, a problem reporting type of feedback may include feedback items submitted to report a problem for the pilot project. Other examples include, but are not limited to: an action recommending type of feedback that includes feedback items submitted to recommend actions for the pilot project; a question asking type of feedback that includes feedback items submitted to ask questions related to the pilot project; a feature recommending type of feedback that includes feedback items submitted to recommend features for the pilot project; and/or a feature listing type of feedback that includes feedback items submitted to list features of the pilot project.

The project management system generates a user interface for displaying stored feedback items to agents of the organizational entity. The user interface may be served to the agent by a project management server that operates on a machine that is remote to the agent. For example, the agent may download, over a network from a server operating on the remote machine, a document that, when interpreted by the agent's local machine, causes the agent's local machine to display the user interface to the agent on a display that is coupled to the agent's local machine. The server may be hosted in a cloud computing system that assigns a network address to the server. Alternatively, the project management server may operate on the agent's local machine, optionally behind a firewall, serving the interface to the agent via the display. In one embodiment, the server uses components on the agent's local machine and components that are downloaded on-demand. For example, project management system logic on the agent's local machine may download existing feedback items to be displayed on a user interface that is controlled by the project management system logic. In various examples, user interfaces may be displayed on a desktop computer, a laptop computer, a tablet device, a mobile phone, other computing devices or mobile electronic devices. An agent may also use a phone system, optionally in connection with a transcription system linked to the phone system, which is preferably an automated transcription system, creating a feedback item via the phone system and transcription system, which connects over the phone network and interfaces with the system interface and creates a new feedback item. The system may comprise an embeddable file enabling the collection of feedback data and system activity data. A user interface may be presented via an embeddable file accessible to an agent directly by an internet browser or within an application or kiosk, enabling the collection of a feedback item and optionally operable to present data back to the agent. User interfaces may simultaneously be provided to a plurality of agents, on same or different local or network connected remote machines, by same or different instances of project management servers. The agents may use the interfaces to create new categories of feedback items or view, modify, take screenshots/video capture, comment on, mark up, tag, categorize, organize, connect, combine, split, promote, demote, certify, share, or rate existing feedback items.

Multiple users of the project management system form a community of users. In one embodiment, each user is an agent of a specialized community called an organizational entity. An organizational entity is a collection of agents with specialized roles, responsibilities, duties, assigned tasks, and/or privileges. The project management system may provide access to users inside and outside of the organizational entity, and may have users in multiple organizational entities. The users may collaborate by accessing virtual servers running in a cloud computing system or other remote access system. In another embodiment, each user can be of a particular type of role, across numerous organizational entities. For example, CIOs of various public sector entities may form an organizational entity for the purpose of performing a pilot project and sharing information among their organizations.

Agents are specialized components of an organizational entity. The agents may be in the same or different companies, the same or different departments or divisions within a company, or other same or different business entities or groups of agents. For example, a company is an example organizational entity that includes the company's employees, contractors, and/or other members as agents, and a division is an organizational entity within the company that includes the division's members as agents. The agents may have same or different roles, responsibilities, duties, assigned tasks, and/or privileges. For example, one agent may be a supervisor, and another agent may be supervised by the supervisor.

In one embodiment, for an existing pilot project, the project management system enables display, to an agent on a type-selection interface, of two or more options, each corresponding to a different type of feedback on the pilot project. In one example, the options are presented to the agent on the type-selection interface as distinct graphical elements. The project management system receives, from the agent as user input, a selection of an option to view and/or create feedback items of particular types. If the agent selects a first option corresponding to a first type of feedback, the project management system causes display, to the agent on an item-viewing interface, of a first set of feedback items of the first type along with an option to create a new feedback item of the first type. Similarly, if the agent selects a second option corresponding to a second type of feedback, the project management system causes display, to the agent on the item-viewing interface, of a second set of feedback items of the second type along with an option to create a new feedback item of the second type. The project management system may also enable a display to the agent of an option to alter the number of feedback item categories, the titles or other label of feedback item categories and may also cause to display to the agent an open field for the collection of new feedback items.

An agent may view one or more types of feedback items at a time on the item-viewing interface. The item-viewing interface allows the agent to sort, rank, pin, assign, share, filter, order, rate, select, modify, subscribe or unsubscribe to, and/or comment on the feedback items. Filtering may comprise filtering by assigned items, open/closed/in progress status, job title of initial agent, job title of another participating agent, open items, etc. For example, graphical element(s) may be displayed next to each feedback item, and the agent may select particular graphical element(s) to rate a corresponding feedback item. The rating of the feedback item may indicate a utility of the feedback item to the agent who rated the feedback item, or a sentiment of the agent regarding the feedback item. The project management system may group the feedback items according to type, date, author, rating, view count, number of ratings, title, topic, department, or other category.

In one embodiment, the project management system determines a set of feedback items to display to the agent based at least in part on both the type selected by the agent and the access privileges of the agent. For example, if the agent selects to view a first type of feedback items, the project management system may identify a subset of feedback items of the first type to which the agent is authorized access. Based on the access privileges of the agent, the agent may be authorized to access the subset of feedback items but not another set of feedback items of the first type. In one embodiment, different agents are authorized to provide different types of feedback. For example, a first agent may be presented with an option to view or create feedback of a first type but not of a second type, and a second agent may be presented with an option to view or create feedback of a second type but not of a first type. In this manner, the project management system may target certain groups of users for collecting certain types of feedback, and other groups of users for collecting other types of feedback.

If the agent has selected to view reported problems, the item-viewing interface may include, in addition to a list of reported problems, graphical indications that indicate whether or not the problems have been solved. Some of the reported problems may have been solved, and others may not have been solved. The status of the reported problems may be updated by agents as the problems are solved, and the updated status is viewable by other agents using the item-viewing interface. Agents may also add or remove problems from the list of reported problems for display to other agents.

If the agent has selected to view recommended actions, the item-viewing interface may include, in addition to a list of recommended actions, graphical indications that indicate whether or not the recommended actions have been attempted. Some of the recommended actions may have been attempted, and others may not have been attempted. In one embodiment, the graphical indications may indicate whether or not the recommended actions worked or did not work when the actions were attempted. Some of the recommended actions may have worked according to a stated purpose or user-specified promotional text, and others may not have worked according to the stated purpose or user-specified promotional text. The status of the recommended actions may be updated by agents as the recommended actions are attempted, and the updated status is viewable by other agents using the item-viewing interface. Agents may also add or remove recommended actions from the list of recommended actions for display to other agents.

If the agent has selected to view asked questions, the item-viewing interface may include, in addition to a list of asked questions, graphical indications that indicate whether or not the asked questions have been answered. Some of the asked questions may have been answered, and others may not have been answered. The status of the asked questions may be updated by agents as the asked questions are answered, and the updated status is viewable by other agents using the item-viewing interface. Agents may also add or remove questions from the list of asked questions for display to other agents.

If the agent has selected to view existing features of the pilot project, the item-viewing interface may include, in addition to a list of existing features, graphical indications that indicate whether or not the features have been rated, or whether they have been rated positively or negatively. Some of the features may have been rated with a positive rating, some may have been rated with a negative rating, some may have been rated with a neutral rating, and others may not have been rated at all. The status of the existing features may be updated by agents as the features are discovered and evaluated by the agents, and the updated status is viewable by other agents using the item-viewing interface. Agents may also add or remove features from the list of existing features for display to other agents.

If the agent has selected to view recommended features that do not yet exist for the pilot project, the item-viewing interface may include, in addition to a list of recommended features, graphical indications that indicate whether or not other agents have voted for the features, or whether the votes for the features were positive or negative. Some of the features may have received positive votes, some may have received negative votes, some may have received neutral votes, and others may not have received any votes. The status of the recommended features may be updated by agents as the recommendations are discovered and evaluated by the agents, and the updated status is viewable by other agents using the item-viewing interface. Agents may also add or remove features from the list of recommended features for display to other agents.

The project management system may also cause display, to the agent, of an ending time of a current phase of a pilot project that is being managed. The ending time or deadline may help the agent determine when to provide feedback on the pilot project. The deadline may be specified by a particular agent, such as a manager, who creates or manages the pilot project. The deadline may be displayed to the agent in a notification to the agent via a text message, a voice message, or an email message; on a home page of a user interface for the agent after the agent has been authenticated into the project management system; along with options, presented on the interface, to view or create feedback items of the different types; or as feedback items of a particular type are being viewed or created by the agent on the interface. In one example, agents may be allowed to provide feedback during an evaluation period that spans from a beginning time to an ending time. After the ending time, the project management system may block agents from submitting further feedback on the pilot project.

In one example, the project management system receives a first selection by a particular agent to view or create feedback items of a first type. In response, the project management system causes display, to the particular agent, of a first set of feedback items of the first type along with a second option to create a new feedback item of the first type. The project management system may then receive a second selection by the particular agent to create a new feedback item of the first type. In response to the second selection, the project management system causes display, to the particular agent, of a third option to create the feedback item anonymously. For example, in a user interface region where the particular agent creates a feedback item of the first type, the project management system may cause display of a checkbox that indicates whether or not the new feedback item should remain anonymous with respect to the agent who is creating the new feedback item. If the anonymous option is not selected, the project management system stores a public association between the first feedback item and the particular agent. The public association is accessible to other agents such that the other agents, when viewing information about the new feedback item, can see that the new feedback item was created by the particular agent.

On the other hand, if the anonymous option is selected, the project management system does not store the public association and does not allow other users to see that the new feedback item was created by the particular agent. In one embodiment, the project management system does not store any association between the new feedback item and the particular agent. In another embodiment, the project management system stores a private association between the first feedback item and the particular agent. Although the private association is not accessible to other agents, the private association may be accessible to the particular agent. For example, on a feedback history interface, the particular agent may view feedback items he or she previously submitted, whether or not those feedback items were submitted anonymously.

The particular agent may also manage notification preferences with respect to feedback items whether or not the feedback items were submitted anonymously. In one embodiment, in response to a request from the particular agent or automatically upon creation of a feedback item, the project management may create a private subscription for the particular agent to receive updates for the feedback item. The private subscription is not accessible to or viewable by other agents, but the private subscription causes the particular agent to receive a notification when the project management system detects an update to the feedback item. In other words, an anonymous author may receive updates about his or her feedback items, and optionally provide further anonymous or non-anonymous feedback in response to the updates, without indicating to other users that the author is receiving the updates.

In another embodiment, the project management system also manages public subscriptions. In response to a request from a particular agent or automatically upon creation of a feedback item, the project management system may create a public subscription for the particular agent to receive updates for the feedback item. The project management system detects an update to the feedback item and, in response, notifies the particular agent of the update. The public subscription is accessible to or viewable by other agents. In other words, when displaying the feedback item to other agents, the project management system may provide a graphical indication that the particular agent is subscribed to the feedback item.

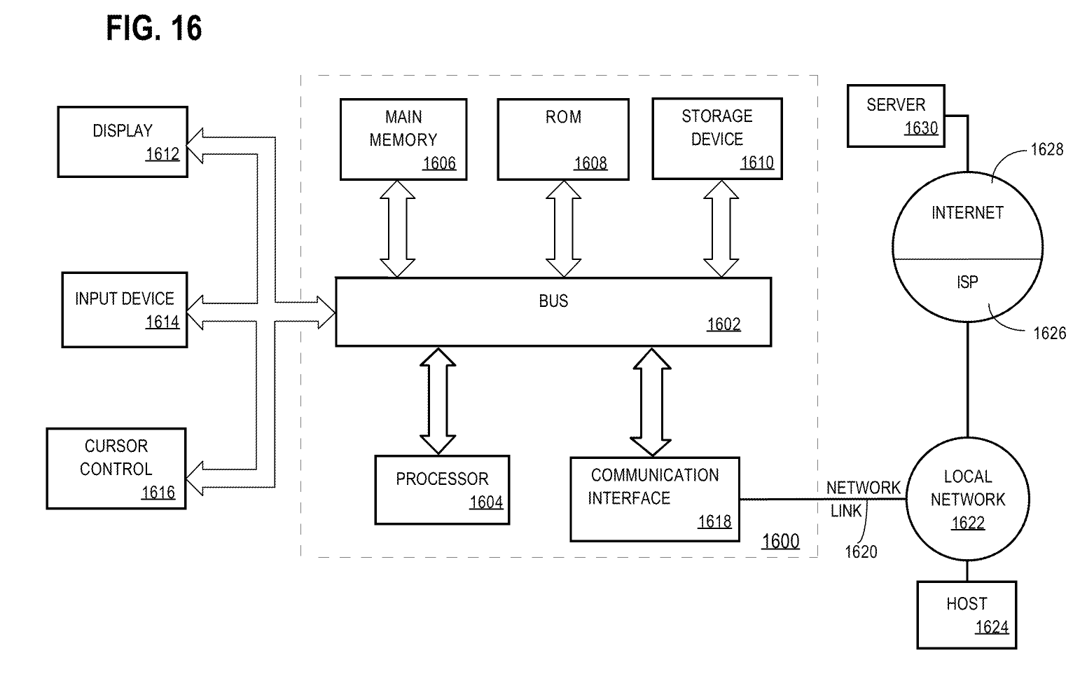

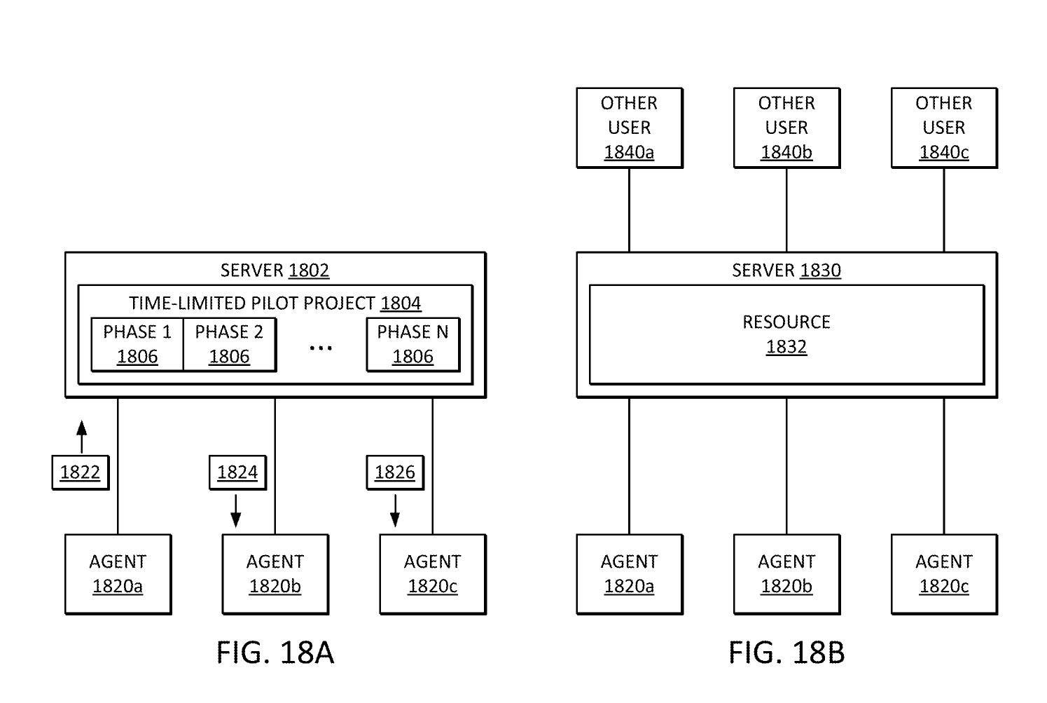

The processes described below with respect to the flowcharts in the figures can be performed with the systems of FIG. 16 or FIGS. 18A-B. Actions such as displaying and outputting can be performed with the display 1612. Actions such as receiving input or information from a user or agent can be performed using the input device 1614 or cursor control 1616. Actions such as storing and saving can be performed with the memory 1606, storage device 1610, host 1624, or server 1630, 1802. Actions such as communicating, sending, and receiving information can be performed using the communication interface 1618. Actions such as processing, running, executing, determining, and calculating can be performed using the processor 1604, the host 1624, or server 1630, 1802.

### Starting and Performing a Pilot Project

In one embodiment, a user or agent may start a pilot project to collect feedback from other users or agents of the project management system. The user starts by registering for the project management system, logging into the project management system as a registered user, or proceeding as a guest user of the project management system. The project management system causes display of an option to create a new project or view existing projects. The user may browse existing projects, sorted, organized, or filtered based on features of the existing projects. Alternatively, the user may create a project to collect feedback from other users of the project management system.

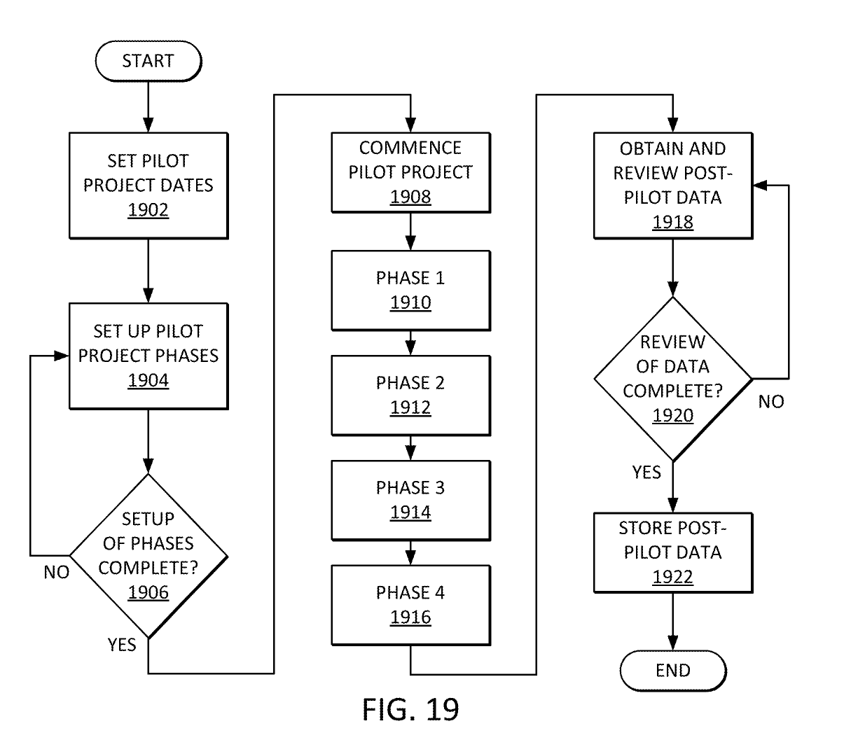

FIG. 19 can be referenced for an overview of a process for creating and performing a pilot project. When defining the pilot project, at step 1902, the author of the project (that is, the user creating the project) provides information such as the starting time, ending time, or duration of the project. A starting time or ending time can be expressed as a date, time, or combination of such. A duration can be expressed in terms of hours, days, weeks, or months, for example. In one embodiment, only the ending time or duration is selected, with the starting time being automatically selected to be the time the pilot project was created. In another embodiment, a user may establish phases and select dates for each of the phases.

At step 1902 or 1904, the project management system can also prompt the user for a project definition that includes topic(s), sub-topic(s), type(s) of feedback, group(s) of agents, categories, keywords, or other properties of the new project. The topics and sub-topics of a project provide other users with a short summary or title of the project. The topic or sub-topics may also identify a goal, task, objective, risk, mitigation strategy, probability of risk occurrence, severity of risk occurrence, budget, or other promotional text tailored to spark the interest of other users in the project. The author of a project may request different types of feedback, and the system may correspondingly enable the prescheduling and automation of feedback requests, and may store templates of previous types of feedback requests, including a subset of or all of the available types of feedback defined in the project management system. The author may also define new types of feedback. Newly defined types of feedback are saved by the project management system for use by other users.

Different types of feedback may be distinguished by more than the topical nature of the feedback. That is, different types of feedback can have different data types when stored and can be obtained using different processes. For example, a type of feedback for rating an aspect of a pilot project can be obtained by a process having a single step that prompts an agent for a numerical rating and then can be stored as an integer. On the other hand, a different type of feedback for capturing textual comments about an aspect of the pilot project may be obtained using a multistep process and then may be stored as one or more text strings. On the other hand, a different type of vocal feedback may be captured, for example via a phone system, and transcribed, for example via a transcription system, and stored by the system. On the other hand, video-based feedback can also be captured, compressed and stored by the system. On the other hand, the system, via an embeddable feedback entry and presentation system can track certain actions taken by agents of the technology upon which the embeddable system is implemented, to store agent usage data and transform usage data into more easily usable forms of data.

The project management system may propose groups of agents for the new project based at least in part on the topic, sub-topic, or other property of the new project. For example, the new project may be categorized, based on the topic or based on a user-specified category, as an IT project. The project management system may suggest members of the IT department as possible groups of agents that could participate in the project. The project management system may also suggest members closely related to other members who have been added to a list of invitees for the project. For example, inviting a manager to participate in the project may cause the project management system to invite other managers or employees working under the manager. The user may refine a list of invitees suggested by the project management system for the project, or the user may create a list of invitees without receiving any suggestion from the project management system. Invitees for the project may be notified of the duration, starting time, and/or ending time so that the invitees are aware of the need to provide feedback during pendency of the project.

The project management system can also automatically schedule an initial meeting between agents. The project management system can, for example, construct meeting invitations and send such in the form of e-mail messages to agents. The agents can then accept or decline such invitations. Known calendaring systems, such as Microsoft Exchange™ or Google Calendar™, using known formats can be used to facilitate this. The initial meeting can be to establish or review the above project properties, determine a project budget, or to determine the phases of the project. A proposed meeting time may be intelligently determined by the project management system by, for example, determining a time that each invited agent is available by querying the calendaring system.

At step 1904, phases of the pilot project can be set up. A number of phases and duration of each phase can be selected by the author of the project. The project management system may suggest a number of phases, their durations, as well as goals for each phase. Such suggestions can be overridden by the author of the pilot project. In one example, the project management system automatically suggests four phases as follows:

### Phase 1—Setup, Troubleshooting, and Risk Identification

Phase 2—Scenario and Field Testing

Phase 3—Best Practice Collection and Process Generation

Phase 4—Pilot Conclusion: Cost Benefit, Goal Achievement, and Risk Analysis

When automatically suggesting phases, the project management system can further automatically suggest a duration for each phase based on the total duration of the pilot project. The duration for each phase can be selected according to a predefined ratio of phase duration to total duration.

When the project management system suggests phases, the phases can be reviewed and changed until accepted by the author, at step 1906. Steps 1904 and 1906 can be an iterative process, in which the pilot project author enters or changes phase properties (e.g., number, goal, duration) and the project management system suggests phase properties based, at least in part, on input from the author.

Once the project management system has collected the project definition from the author, the pilot project commences, at step 1908. The project management system stores the project definition for access by the groups of agents or project invitees who are authorized to access the project. In one embodiment, the project management system sends invitations to the user-specified groups of agents in the project definition. The invitations may request feedback, by the agents, of the user-specified types of feedback. Different groups of agents may receive different invitations requesting different types of feedback.

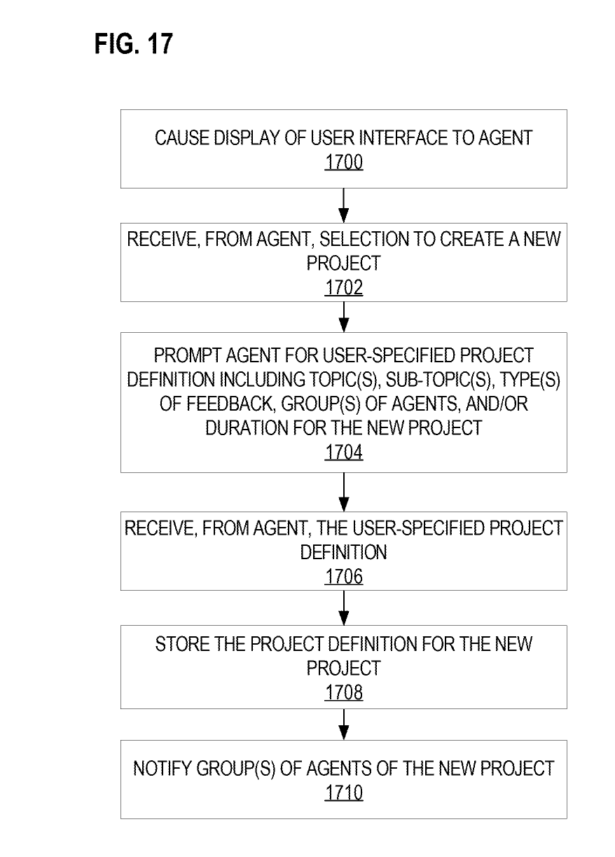

FIG. 17 illustrates an example process for creating a project for evaluation by a group of agents. The process of FIG. 17 can be performed as any of steps 1902-1908 of the larger process of FIG. 19. As shown, in step 1700, the process includes causing display of a user interface to an agent. The interface may include an option to create a new project. In step 1702, the process includes receiving, from the agent, a selection to create a new project. The user is prompted for the project definition in step 1704. The project definition may include, for example, topics, sub-topics, types of feedback, groups of agents, invitees, or participants, and/or a specified duration. The process receives the user-specified project definition in step 1706 and stores the definition for the new project in step 1708. Optionally, in step 1710, the process notifies groups of agents that they have been added as participants of the new project.

After commencement of the pilot project, at steps 1910, 1912, 1914, and 1916, the phases are performed in order at the selected times and for the selected durations. At each phase 1910-1916, the project management system can issue reminders to agents participating in the pilot project to provide feedback. Such reminders can be via any kind of electronic communication, such as e-mail, instant message, or other technique, such as those described elsewhere herein. The content of the reminders can be associated with the goal of the current phase and can include, for example, a reminder to provide feedback on troubleshooting or setup (e.g., Phase 1), a reminder to provide feedback on scenario testing or a reason why such testing cannot be performed (e.g., Phase 2), a reminder to perform budgetary assessment for relevant phases, or a reminder when the a phase is nearing completion.

These kinds of reminders can be particularly advantageous to pilot projects, as pilot projects tend to be shorter and faster moving than other kinds of projects. Members of organizations that implement the techniques described herein may be more familiar with longer-term projects, so the reminders discussed herein can be advantageous in obtaining feedback on the pilot project in a timely manner.

At each phase 1910-1916, the project management system can also automatically schedule meetings between agents. The project management system can, for example, construct meeting invitations and send such in the form of e-mail messages to agents in a manner similar to that discussed above with respect to the initial meeting. The project management system can facilitate automatically scheduled video-meetings for remote workers. This can be done by, for example, project management system associating meeting invitations with a video conferencing service such as Skype™, WebEx™, GoToMeeting™, or similar. A meeting invitation may include a hyperlink to such a service, the hyperlink indicating the specific meeting.

After each phase, or predetermined project interval (such as one month) is complete, and after the project is complete, post-phase data can be obtained and reviewed at, for example, step 1918. The feedback and other informational items gathered during the phases 1910-1916 can be analyzed. The project management system can generate metrics such as a level of engagement of the agents (e.g., average number of feedback items per agent, and maximums or minimums), an indication of influential agents (e.g., agents who provided the most feedback or whose feedback was highly rated), an indication of adopting agents (e.g., agents who reported features to be useful or encouraged others to try new features), budget overruns or surpluses, risk realization and probabilities of occurrence and recurrence, and the like. A report or a recommendation can be generated for the pilot project to summarize how it met or failed to meet its goals, and may include an assessment of whether the goals were met within the period and projections based on widespread organizational adoption of the subject of the pilot project.

An example monthly report during performance of the pilot project can contain a sentiment analysis of the project and its phases. The monthly report can also include an interface that prompts agents for the amount of budget spent to date and provides a budget update. Statistics and trends, such as those discussed elsewhere herein, can also be provided.

Once the review of the data is determined at step 1920 to be complete, the feedback and other informational items gathered during the phases 1910-1916 can be stored as a resource for future reference, at step 1922. If the subject of the pilot project is adopted by the organization for widespread use, individuals of the organization can reference the resource generated by the pilot project for helpful information.

It should be apparent from the process of FIG. 19 that the process can allow for iteration (steps 1906 and 1920) before and after the phases of the pilot project. That is, input and output aspects of the project (e.g., goals and reports) can be fine-tuned over any length of time. On the other hand, the process can allow for successive performance of each phase 1910-1916 without any conditions, other than phase ending times, for passing from one phase to the next. When so performed, the process can be advantageous in that the pilot project remains on schedule and is performed in a resource-efficient manner. This can help motivate agents to provide feedback, rather than allow agents to shift the scope or deadlines of the project during its execution.

In one example, a company executive decides that a group of agents should try out devices, such as iPad™ tablet computers, or a service, such as Salesforce.com™. The executive creates a project in the project management system and invites the group of agents to provide various types of feedback on the project. For example, the agents can use the project management system to discuss the topic of the project (i.e., the tool or technology), collaboratively troubleshoot any issues that arise during the project, share practices and processes that worked for the project, share great features of the tool or technology, and suggest new features or improvements to the tool or technology, and assign the feedback items across multiple stakeholder groups and individual agents.

In one embodiment, agents participating in a project can provide collaborative input to the project management system in real-time without the wasted time of meetings and forgotten reactions/issues. Agents who might otherwise not want to call IT with all their troubles can post a quick message to see if any other agents in the organization have an answer or have already posted an answer. The company using the project management system may have a continuously evolving archive of proposed practices and processes, frequently asked questions, and trouble-shooting solutions that were initially developed during the trial of a product, and used to facilitate evaluation of the product and adoption of the product throughout the rest of the company. The project management system may show executives of the company how the agents of the organization feel about the new tool, as well as identify parts of the new tool that are most problematic. For example, the project management system may identify lowly-rated features or actions or frequently viewed troubleshooting items, or areas of the application where agents are spending longer than usual and may be experiencing troubles or discovering interesting content.

Feedback items may be organized based on project to facilitate efficient evaluation of the project and expanding the project to cover other groups of agents in the company. Feedback items that report and solve problems may be organized based on project and topic or sub-topic within the project. Executives may share this organized feedback with new groups of agents as projects are implemented with the new groups of agents.

FIG. 18A shows an overview of a pilot project according to this disclosure. One or more servers 1802, such as a server 1630 (FIG. 16), stores information that defines a time-limited pilot project 1804 composed of any number N of phases 1806. Each phase 1806 has requirements, such as a goal, and a temporal definition, including one or more of a start time, end time, and duration. The processes, interfaces, and other techniques discussed elsewhere is this disclosure allow agents or users 1820a-c to participate in the pilot project 1804 by providing feedback and other information 1822, by viewing feedback and other information 1824 provided by other agents, and by receiving and responding to reminders or calendar invitations 1826 from the server 1802. The agents 1820a-c can each use a device, such as a computer system 1600 (FIG. 16), to interact with the server 1802 via a network (FIG. 16). Thus, the pilot project 1804 may operate as what is known as software as a service (SaaS) or a cloud-based application.

Referring to FIG. 18B, after the final phase of the pilot project 1804 is completed, feedback and other information obtained during the pilot project can be stored as a resource 1832, at a server or servers 1830, which may be the same as the server or servers 1802 or may be different. Such resource 1832 can be accessible to the pilot project agents 1820a-c as well as to a wider group of individuals 1840a-c of the organization, who may wish to reference the resource when using the technology that was the subject of the pilot project 1804. The agents 1820a-c and other individuals 1840a-c can each use a device, such as a computer system 1600, to interact with the server 1830 via a network. The network over which the resource 1832 is made accessible can be the same as or different from the network over which the pilot project 1804 is conducted. For example, the pilot project 1804 may be conducted over the Internet, while the resource 1832 may be made available over a private network of the organization.

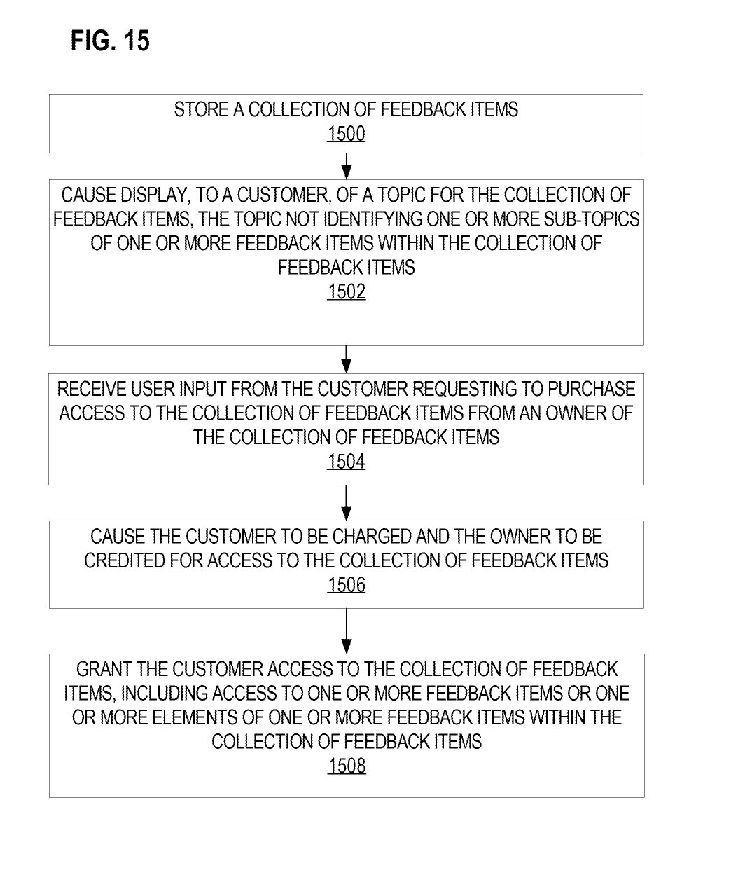

In another example, any of agents or users 1820a-c and 1840a-c include individuals of another organization that has purchased access to the pilot project 1804 or the resource 1832. Access to feedback items of the project 1804 or resource 1832 can be sold, as discussed elsewhere herein and particularly with respect to FIG. 15. In the scenario where a technology is the subject of the pilot project, it may be advantageous to allow access to the pilot project 1804 by a representative from the company that makes or provides the technology, since this may allow such company to use feedback from an ongoing pilot project to rapidly improve their technology.

In the following description, the systems and processes of FIGS. 16, 18A-B, and 19 can be referenced.

### Inviting Others to Create, Modify, or Evaluate Feedback Items

In one embodiment, a user interface of the project management system allows users to invite others to create, modify, or evaluate feedback items about a pilot project. For example, a user may specify, via the user interface, a project, a topic or sub-topic, or a completed or partially completed feedback item that should be further developed by a group of users such as the user's team. The user may select an option, presented via the user interface, to send invitations to a group of users such as his or her team members via e-mail, voicemail, text message, instant message, or by some other message or posting that is made accessible to the members of the group. In response to the user's selection of the option, the project management system automatically generates and sends invitations to the members of the group. For example, the project management system may add recipients and item-specific, topic-specific, or project-specific information to a template invitation message. Invitations to request further development of content by the group specify a request that the group members provide further input on the item, topic, or project.

Upon receiving an invitation, an invitee may select a link or other reference in the invitation to cause the project management system to create an account for the invitee, authenticate the invitee as a user of an existing account, or proceed as a guest of the project management system. The invitee may then use the user interface of the project management system to review the feedback item, topic, or project, and provide the feedback requested by the invitation.

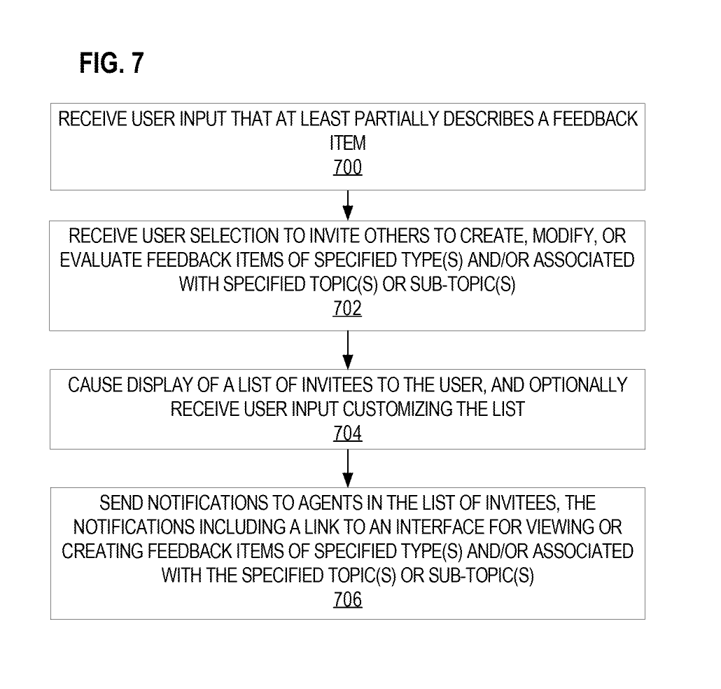

FIG. 7 illustrates an example process for inviting others to provide feedback item input. The process includes, in step 700, receiving user input that at least partially describes a feedback item. In step 702, the process includes receiving user input that selects to invite others to create, modify, or evaluate feedback items of specified types and/or associated with specified topics or sub-topics. The process causes display of a list of invitees to the user, and optionally receives further user input that customizes the list displayed to the user, in step 704. In step 706, notifications are sent to agents in the list of invitees. Each notification may include a link or other reference to an interface for viewing or creating feedback items of specified types and/or associated with specified topics or sub-topics.

### Collecting Different Types of Feedback

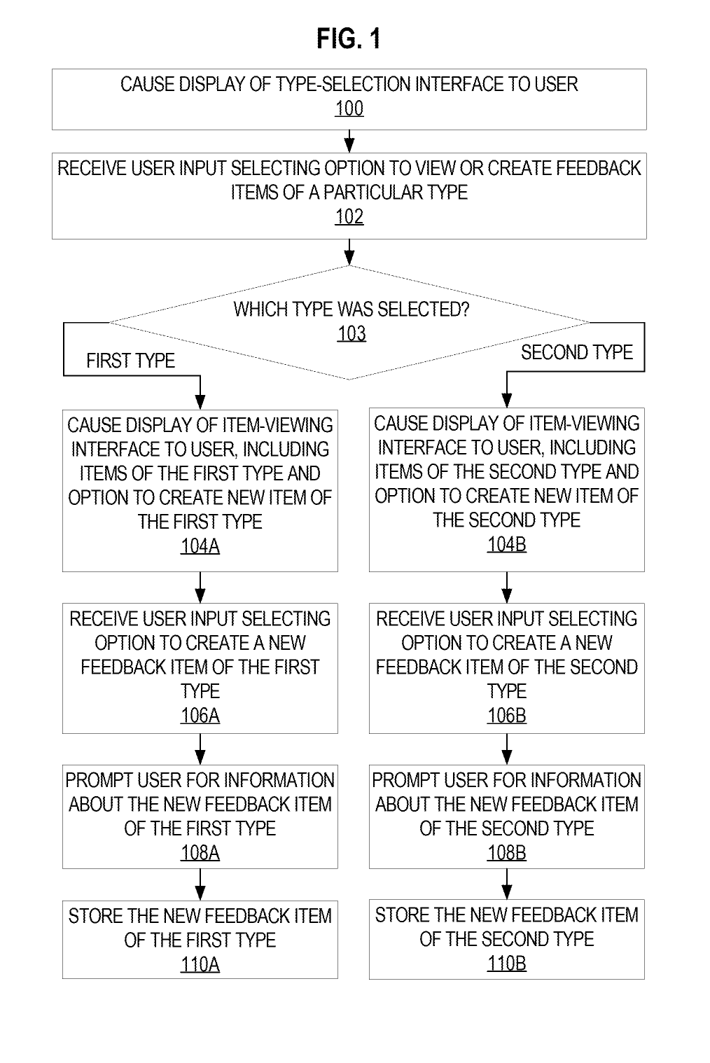

FIG. 1 illustrates an example process for creating feedback items. In step 100, the project management system causes display of a user interface to a user. In step 102, the project management system either presents a field or several fields to input feedback data of preselected or open types, or receives user input selecting an option to view or create feedback items of a particular type. The project management system determines which type was selected in step 103, and, based on the selected type, causes display of an item-viewing interface to the user. If the first type was selected, the item-viewing interface includes items of the first type along with an option to create a new item of the first type, as shown in step 104A. If the second type was selected, the item-viewing interface includes items of the second type along with an option to create a new item of the second type, as shown in step 104B. The project management system then receives user input selecting the option to create a new feedback item of the selected type, as shown in step 106A for the first type and step 106B for the second type. Upon selection of the option to create the new feedback item of the selected type, the user is prompted for information about the new feedback item of the selected type in steps 108A and 108B. The project management system may prompt the user for different fields of information depending on the different types of selected feedback. The project management system stores the new feedback items in steps 110A and 110B. The feedback items may be shared among various instances of the project management system such that other users using other instances of the project management system have access to the newly created feedback items. It may be advantageous to collect feedback of different types from agents in pilot projects in that having agents specify a type of feedback may allow for relatively quick or accurate assessment of feedback.

In one embodiment, users may develop a collaborative set of information about a project by contributing various types of documents and feedback items for various topics and sub-topics of the project. User interface logic of the project management system may present, to a user via a user interface, an option to create a new feedback item. Other options may be concurrently presented to the user along with the option to create a new feedback item. Such other options may include an option to browse, search, or modify existing feedback items, to modify account settings, to view content previously entered by the user, or to view content in a specified category or content for: a specified topic, the user's department, the tasks assigned to the user, or the user's role in the organizational entity. The options may be presented to the user as a series of buttons or other graphical elements that are distinguished from each other by words, shapes, and/or colors. In one embodiment, an option to create a new feedback item of a particular type is presented while the user is browsing feedback items of the particular type.

The project management system receives, from the user via the user interface, a selection of the option to create a new feedback item. In response to the selection, the project management system presents, to the user via the user interface, a user input region for entering information about the new feedback item. The user interface prompts the user to input a name, a topic, a sub-topic, an issue, a sub-issue, related keywords, agents related to the feedback or to be notified of the feedback item, and other information such as information specific to the type of feedback item. For example, the user interface may prompt the user for: a problem or a solution if the type of feedback item is reporting a problem; a question or answer if the type of feedback item is asking a question; an action or result if the type of feedback item is recommending an action; an existing feature if the type of feedback item is listing existing features; or a recommended feature if the type of feedback item is recommending features. The user interface may also allow the user to enter other information, such as a rating or a comment on the feedback item or on one of the elements of the feedback item. Once created, a feedback item may be further customized by same or different users that access and modify the feedback item via the interface.

The feedback item may include or be associated with a set of topics, sub-topics, keywords, tags, or other categories. For example, the feedback item may be tagged or categorized as a sales or marketing item, as an information technology or support systems item, as a finance or accounting item, as an engineering or design item, as a janitorial or maintenance item, as an administrative or management item, as a shipping or receiving item, as a customer service or support item, as an education or training item, as a human resources or benefits item, as a distribution or supply item, or as a public relations or legal item. The feedback item may also be associated with topics based on the phase of the project to which the feedback item relates. For example, a feedback item may be associated with a setup phase, a startup phase, an operational phase, a shutdown phase, or a finishing phase. Any number or variety of categories, keywords, or tags may be associated with a feedback item.

Information may be specified for the feedback item using free-form entry of text that includes a topic-specifying aspect and a type-specific-information-specifying aspect. Information may also be specified by selecting drop-down menus on the interface. Drop-down menus may present pre-defined or system-specified options that represent commonly used topics or commonly used type-specific information. For example, a topic drop-down menu may include the entries “installation” or “setup” to describe feedback about installing or setting up a tool being tested by the project. An example drop-down menu for reporting a problem may include the entry “failure” to describe failure of a tool or “latency” to describe a latency experienced while using the tool. An example drop-down menu for asking a question may include entries such as “who,” “what,” “when,” “where,” “why,” and “how” to describe commonly asked questions. An example drop-down menu for listing existing features may include entries for “hardware,” “software,” “data,” or “synergy” to describe useful hardware, useful software, useful data, or useful synergies discovered while testing the tool. An example drop-down menu for recommending features may include similar entries to describe hardware, software, data, or synergies that would be useful for the tool.

In one embodiment, the user interface of the project management system includes multiple input fields, each input field prompting the user for a different element of the feedback item. For example, the interface may include a topic field for inputting the topic of the feedback item, sub-topic fields for inputting sub-topics of the feedback item, keyword fields for inputting keywords associated with the feedback item, and a type-specific information field for entering type-specific information associated with the feedback item. The interface may display a single field for entering a collection of topics and sub-topics or a collection of items of type-specific information. For example, the user may enter multiple problems, multiple questions, multiple actions, multiple existing features, or multiple proposed features into a single field. Alternatively, the interface may display multiple separate fields corresponding to each of the separate topics or sub-topics or items of type-specific information to be entered. Similarly, other information may be requested separately or in conjunction with the topic information or the type-specific information.

In one embodiment, feedback items are imported from other users at the same or a different organizational entity. For example, feedback item or collection of feedback items may be shared from one user to another user. The two users may be using a different project management system backbone. Upon receipt of feedback item from another user, the recipient may select a location within a hierarchy of feedback items in which to store the received feedback.

In one embodiment, feedback items have a sub-type that describes whether or not the feedback item is a new feedback item or is responsive to another feedback item. In one embodiment, an initial feedback item specifies a possible issue, and a responsive feedback item specifies a possible resolution of the issue. The issue feedback may be a first sub-type of feedback, and the resolution feedback may be a second sub-type of feedback. For example, a type of feedback item may be reporting a problem for the pilot project, and the type of feedback item may have two sub-types: reported problems and responsive solutions. As another example, a type of feedback item may be recommending an action, having two sub-types: proposed or attempted actions for the pilot project and feedback on the proposed or attempted actions. In a third example for the asking a question type of feedback, the sub-types may include questions and answers to the questions. In a fourth example, a type of feedback may be recommending or listing a feature, and the sub-types may be features and feedback about the features.

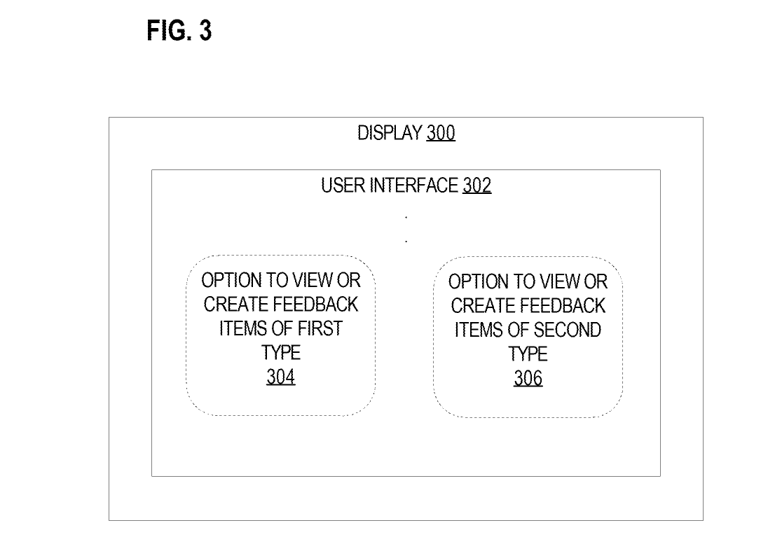

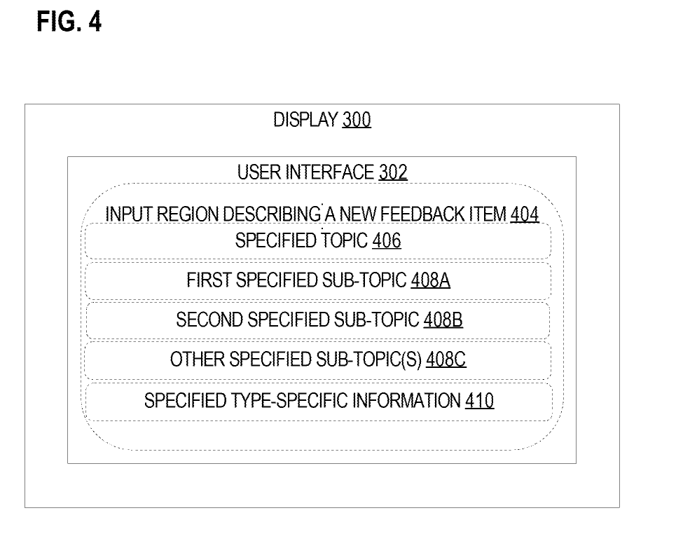

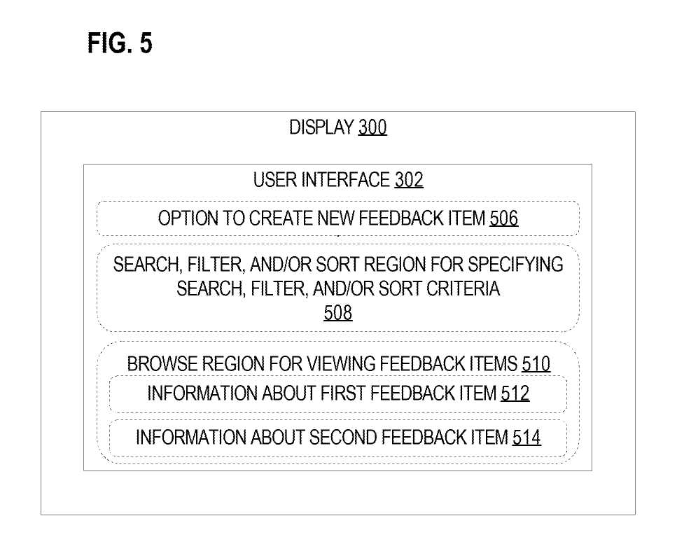

FIG. 3 illustrates an example interface that displays options to create or view existing feedback items of different types. As shown, user interface 302 on display 300 includes an option to create or view feedback items of a first type 304 and an option to create or view feedback items of a different, second type 306. In response to a user selection of option 304, the user may be presented with the example interface for creating a feedback item of a first type, such as the interface illustrated in FIG. 4, or an example interface for browsing feedback items of the first type, with a further option to create a feedback item of the first type, such as the interface illustrated in FIG. 5. As shown in FIG. 4, user interface 302 includes an input region for describing a new feedback item 404. As input is received from the user, the input region may include specified topic 406, a first, second, and other specified sub-topics 408A-C, and specified type-specific information 410. Interfaces similar to or the same as those of FIG. 4 and FIG. 5 may be used for feedback items of a second type 306.

### Creating a Hierarchy of Feedback Items

In one embodiment, the project management system allows users to link feedback items together in a hierarchy of feedback items. Feedback items may be nested within a particular feedback item as children, grandchildren, great grandchildren, or other dependency arrangement of the particular feedback item. Similarly, the particular feedback item may be nested within other feedback items. Users may collaborate using the project management system to add detail and extend a feedback item tree branching from existing feedback items.

For example, users may add or remove elements such as topics or sub-topics, issues or sub-issues, or items of type-specific information from existing feedback items. Users may also create separate feedback items from topics, sub-topics, issues, sub-issues, or items of type-specific information already existing in a feedback item. The separate feedback items may have a child relationship to the previously existing feedback item. One of the separate feedback items may be broken down into several other items of type-specific information. Separate feedback items may then be created for each of these other items of type-specific information.

In one embodiment, a default topic for a new child feedback item is the name specified for an element of the feedback item. For example, a parent feedback item for driving safely may include the elements of starting a car, looking over your shoulder, and driving the car in reverse. The element of starting a car may be broken up into several child feedback items. A first child feedback item for starting a car may include the element of putting a foot on the brake of the car. A second child feedback item for starting a car may include the element of placing a key in the ignition of the car. A third child feedback item for starting a car may include the element of turning the key in the ignition. Each of these elements may be broken up into further elements, and separated into grandchild and great grandchild feedback items, depending on the amount of detail desired by the users of the project management system. The project management system presents the feedback items to a user who is looking for more information about starting a car, which is the topic of several feedback items. In this manner, the project management system advertises or promotes the elements of the feedback item to users by listing the elements under the topic of starting a car. The default topic may be modified by a user who is creating new child feedback items, or the default topic may be updated by a user after the feedback item has been created.

In another embodiment, a default topic for a new child feedback item is the topic specified for the parent of the feedback item. In the example, the topic for the parent feedback item is driving safely. The child feedback items also serve this purpose. Feedback items in the hierarchy may have a locked or unlocked, relevant or irrelevant ordering, as specified by the users collaborating to create the hierarchy of feedback items.

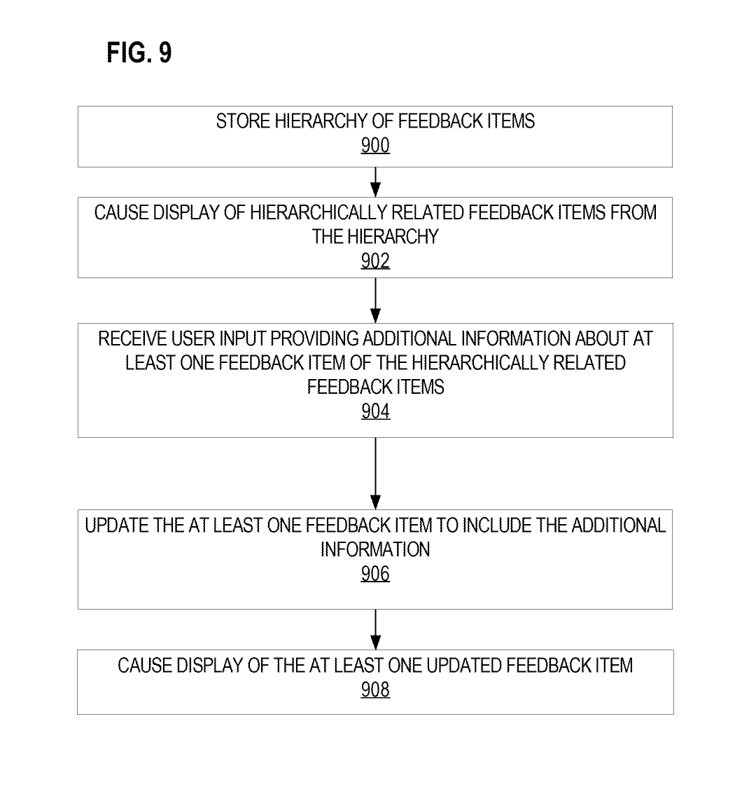

FIG. 9 illustrates an example process for managing input with respect to a hierarchy of feedback items. As shown, in step 900, the project management system stores a hierarchy of feedback items. Hierarchically related feedback items from the hierarchy are displayed in step 902, for example, in response to a user request to view feedback items. In one example, the items are displayed with an indication of how the items are hierarchically related. For example, parent-child relationships may be graphically represented on the interface. The project management system receives, from the user in step 904, user input providing additional information about at least one feedback item of the hierarchically related feedback items. In step 906, the at least one feedback item is updated in storage to include the additional information from the user. In step 908, the project management system causes display of the at least one updated feedback item, for example, to the user or to other users.

### Browsing, Searching, Filtering, and Organizing Feedback Items

In one embodiment, the project management system causes display of an interface to a user for browsing, searching, filtering, and/or organizing feedback items. The user may search for, filter, or organize feedback items based on any element or feature of a feedback item or a collection of feedback items. For example, the user could search for feedback items with a particular topic or issue, feedback items of a particular type, feedback items associated with particular keywords, for feedback items with particular contents of type-specific information, or for feedback items that meet metric thresholds.

In one example, a user searches for feedback items related to a particular keyword. The user enters, via the user interface, one or more keywords as a feedback item query. The feedback item query is processed by the project management system, and a resulting set of feedback items is displayed to the user. The query may be processed based on keyword matching or based on the topical relevance of the query to the result. Processing a query based on topical relevance accounts for the meanings of words rather than merely the words themselves. For each feedback item, summary information such as the topics or descriptive names of feedback items may be presented to the user for further browsing and selection. Other summary information may include an author, authors, or other contributors to the feedback item, categories in which the feedback item is categorized, the type of the feedback item, and tags or other keywords associated with the feedback item. The summary information may also include a portion of the feedback item that caused the feedback item to appear in the result set.

A user may also filter out feedback items from a set of feedback items presented to the user. Like searches, filters may be based on any information associated with the feedback item. In one example, a user filters out feedback items that do not meet a user-specified metric threshold. An example metric is an average or aggregate user-specified rating of the feedback items. In a particular example, a user may filter out feedback items that did not work for at least 50% of the time for users that rated the feedback items. In another example, a user may filter out feedback items that are not preferred by at least 80% of the users that rated the feedback items. In yet another example, a user may filter out feedback items that do not have at least a certain number of ratings. The user may also filter the set of feedback items to only those items that are certified by a certification group, or to only those items that are related to a particular category or department.

A user may rank feedback items based on various metrics or quantifiable characteristics associated with the feedback items. For example, a user may rank items from the items that worked most frequently to the items that worked least frequently, from the items that are most preferred to the items that are least preferred, or from the items that are viewed the most to the items that are viewed the least. The user may also group items by date, category, department, author, agent role to which the feedback item applies, task or product to which the feedback item applies, department or group of agents associated with the feedback item, or any other characteristic of the feedback item.

FIG. 3 illustrates an example interface that displays options to create or view existing feedback items of different types. In one example, selection of the option to view existing feedback items of a particular type causes display of the interface for browsing, searching, and/or filtering feedback items, as illustrated in FIG. 5. User interface 302 includes an option to create a new feedback item 506. User interface 302 also includes a search, filter, and/or sort region for specifying search, filter, and/or sort criteria 508, and a browse region for viewing feedback items 510. Browse region 510 may include information about several feedback items, such as information about first feedback item 512 and information about second feedback item 514. In one embodiment, browse region 510 includes only those feedback items of a particular type that was selected on a previous interface such as the interface shown in FIG. 3. In another embodiment, browse region 510 includes feedback items of various types, and the type of feedback item is one of many criteria on which the feedback items may be searched, filtered, and/or sorted.

### Rating and Evaluating Feedback Items

In one embodiment, the project management system includes a user interface that has an option for creating a ratable feedback item. Upon selecting an option to create a ratable feedback item, a user such as an agent inputs, to the project management system via the user interface, information that describes the ratable feedback item. The specified information is stored, by the feedback item management system, on a computer-readable medium as a ratable feedback item. The stored ratable feedback item may be retrieved, by the project management system, for display to the same or a different agent.

An existing ratable feedback item may be rated by the agent(s) that created or modified the item or by different agent(s). In one embodiment, interface logic of the project management system causes display, to an agent via a user interface, of existing ratable feedback item(s). The user interface allows the agent to specify a rating for a selected existing ratable feedback item.

In one embodiment, the rating is a binary or numerical rating. In another embodiment, the rating is a textual rating. For example, the user may explain in text that the feedback item did or did not work rather than providing a numerical or binary rating for the feedback item. The user may also provide general comments with respect to the feedback item. The user may specify to the project management system whether or not the rating is to remain anonymous.

In one embodiment, the interface allows users to evaluate not only feedback items and collections of feedback items, but also elements and sub-elements of feedback items. For example, the user may indicate that a contextual property or particular detail specified by the feedback item is inaccurate or undesirable. As another example, the user may indicate that some of the details are desirable but other details are not desirable. As yet another example, the user may indicate that a name, topic, issue, or goal for the feedback item is inaccurate even though the content of the feedback is desirable in the specified context.

The interface may graphically delineate one or more of collections of feedback items from feedback items themselves, elements of feedback items from the feedback items themselves, and sub-elements of feedback items from the elements of feedback items. For example, the interface may present collections at a first level of indentation, items at a second level, elements at a third level, and sub-elements at a fourth level. As another example, the interface may draw a first box around a collection, a second box around an item in the collection, a third box around the element in the item, and a fourth box around the sub-element in the element. Ratings or other feedback may be provided at each level of graphical delineation.

In one embodiment, multiple ratings are aggregated into a single rating. For example, the rating may indicate that the ratable feedback item succeeded for 60% of the users and failed for 40% of the users. As another example, the ratable feedback item may indicate that, on average, users have found the ratable feedback item as 70% effective. Multiple statistical measurements may be presented with the aggregated rating. For example, the rating may be presented with the mean rating, median rating, mode rating, number of submissions, standard deviation of ratings, maximum rating, minimum rating, characteristics common to agents who viewed the ratable feedback item positively, and characteristics common to agents who viewed the ratable feedback item negatively.

Agents may optionally provide commentary for an existing ratable feedback item whether or not the item has been rated. For example, a comment may be provided for the existing ratable feedback item by the agent(s) that created, modified, or rated the item or by different agent(s). Comments may be rated by other agents separately from the ratable feedback item.

In one embodiment, the project management system makes rated feedback items, with or without added commentary, concurrently accessible to the agent(s) that created or modified the item, by the agent(s) that rated the item, by the agent(s) that commented on the item, or by different agent(s). In one embodiment, the project management system makes feedback items, with or without a rating and with or without commentary, accessible only by a subset of agents of the organizational entity. Agents attempting to access the feedback items may be authenticated by the project management system, via the user interface, in order to determine whether the agents belong to the subset of agents that are allowed to access the items. The project management system may allow different agents to access different or same items. In one embodiment, the role of the agent in the organizational entity controls whether or not the project management system grants the agent with access to a feedback item. Some agents may have administrative access to all feedback items, and other agents may have access only to public feedback items that do not require authentication.

Various user ratings, other user feedback, and other metrics about feedback items may be gathered from users based on the feedback items. These metrics may be used to analyze the feedback items that were promoted by the authors of the feedback items. Analyzing a feedback item based on collaboration among a plurality of users may allow the project management system or a user of the project management system to identify a choke point in an organizational practice, an organizational process, or for a product or feature of a tool used by the organization. For example, a choke point in an organizational practice may be indicated by a poorly rated feedback item or element of a feedback item. The choke points may reveal areas for further focus and development by agents of the organizational entity.

In one embodiment, the metrics are aggregated to provide an overall view of the results of performing the feedback items. For example, aggregating ratings that specify whether or not a feedback item worked to support the topic may result in an aggregated rating that indicates the feedback item worked for 70% of the users. Alternatively, an aggregated rating may indicate that the feedback item received a minimum rating of 3 points and/or a maximum rating of 8 points out of 10 points on a 10-point satisfaction scale.

Other functions may also be useful in analyzing the metrics collected as a result of user collaboration in testing and rating the feedback items. For example, a statistical analysis may indicate the standard deviation of user scores, or a trend in user scores. The user scores over time may be fitted to a linear or nonlinear equation, or some other approximation, to predict future scores.

In one embodiment, analysis of the metrics includes weighing metrics received from some sources as more valuable than metrics received from other sources. For example, metrics used from sources that are not directly participating in a project may be given less weight than metrics received from sources that are assigned duties or tasks for the project. Also, some users may be considered to be more accurate or more influential than other users. Users may be ranked according to their accuracy, influence, or role in the organizational entity, and these rankings may be accounted for in the overall rating.

In one embodiment, sentiment indicated in user comments may be quantified into a rating that can be aggregated with other ratings. For example, user comments with a high frequency of positive words and/or a low frequency of negative words may be given higher ratings than user comments with a high frequency of negative words and/or a low frequency of positive words. As another example, user comments may be parsed into nouns, adjectives, verbs, and adverbs. A comment with nouns and verbs associated with the feedback item may receive a positive rating when modifying adjectives and adverbs are positive, and a negative rating when the modifying adjectives and adverbs are negative.

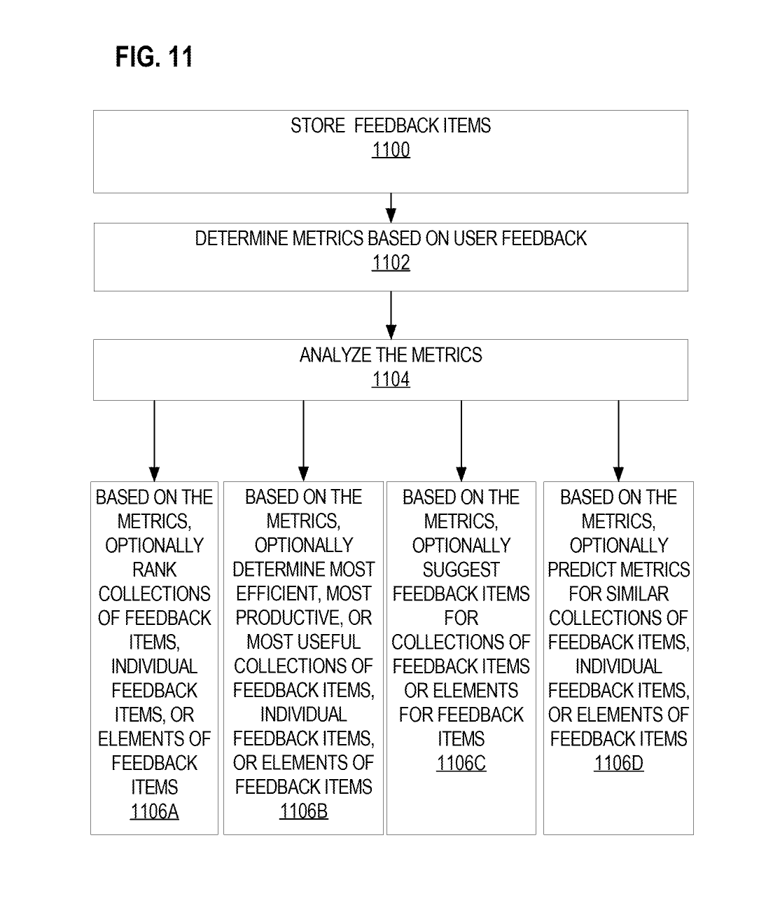

FIG. 11 illustrates an example process for analyzing metrics based on user feedback. The process stores feedback items in step 1100. Metrics are received or determined based on user feedback in step 1102. The metrics are related to various instances of testing a tool or technology that is the subject of a project. The project management system analyzes the metrics in step 1104. In one embodiment shown in 1106A, based on the metrics, the project management system ranks collections of feedback items, individual feedback items, or elements of feedback items. In another embodiment shown in 1106B, based on the metrics, the project management system determines the most efficient, most productive, or most useful collections of feedback items, individual feedback items, or elements of feedback items. In yet another embodiment shown in 1106C, based on the metrics, the project management system suggests feedback items to be included in collections of feedback items, or elements of feedback items to be included in feedback items. In the embodiment shown in 1106D, based on the metrics, the project management system suggests metrics for similar collections of feedback items, individual feedback items, or elements of feedback items.

### Identifying Risk

In one embodiment, the project management system allows users to select an option to list or provide feedback of a type designated to identify risk. Risk can be financial, engagement, technological, ecological, or other kind. The project management system may suggest risks or risk categories.

In one embodiment, the feedback type for risk can include an identification of the risk, a probability or likelihood of occurrence, and an associated severity or impact when occurring. For example, supposing a new network device is the subject of the pilot project, an agent may identify one risk as “poor bandwidth performance” and may indicate a probability of “30%” and a severity of “very severe”.

Risk identification can be part of the initial pilot project set up, such as part of step 1902 of FIG. 19. Accordingly, an evaluation of whether risks were realized or not and the actual severity and impact can be conducted as part of the post-project review of step 1918 or as part of a periodic (e.g., monthly) review process. Alternatively or additionally, risk identification can be an ongoing topic for feedback, and accordingly can submitted and reviewed via the user interfaces and processes discussed elsewhere herein in a manner similar to the other feedback types. Risk may be evaluated at a specific phase of the pilot project, and accordingly, risks can be identified at step 1904 and evaluated at project completion (e.g., step 1918), periodically, or during the respective phase (e.g., step 1910-1916).

A risk feedback item can include votes by other agents on the likelihood or severity of the risk. Such can be achieved by child feedback items, as discussed with respect to FIG. 9 and elsewhere.

One advantage of having risk as a feedback item is that users in different parts of the organization (e.g. the front lines) may have more accurate insight into the likelihood or severity of risk and be better at identifying risk factors.

### Reporting and Evaluating Problems

In one embodiment, the project management system allows users to select an option to search for or provide feedback of the type that reports problems and solutions to the problems. A user may initially search for problems to see if the project management system includes a similar problem. In one example, the user searches based on a category, topic, or summary of the problem. If the user finds the problem in the project management system, the user may determine whether or not the problem has been solved. The solution may indicate one or more steps to be taken by users experiencing the problem. If the problem has been solved, the user may exit the project management system and practice the solution. The user may also provide feedback regarding the success of the solution for the user, or the sentiment of the user towards the solution. For example, the user may indicate that the user experienced the same problem and/or that the solution worked for the user. As another example, the user may like or dislike or rate the problem and/or the solution.

If the problem has not been solved, the user may use the project management system to add to an existing feedback item or add a new feedback item that describes the problem in detail. For example, the user may describe one or more contextual properties or environment characteristics that explain how the problem was produced or how the problem can be replicated by other users. Users may also describe the severity of the problem and provide information about how the problem affects the project, the tool or technology, or performance metrics associated with the organizational entity, such as profitability of the organizational entity. The user may also invite other users to offer solutions to the problem. For example, the user may share the problem with his or her team of engineers. As another example, the user may share the problem with agents of a different department. For example, the user may share the problem with a group of agents who are typically responsible for handling such problems, such as the IT department.

If another user is invited to solve the problem, the other user may see in the project management system how many users have indicated they are experiencing the problem and how many users have viewed the problem. Such information may be indicative of the severity of the problem to the organizational entity or to the project. In one embodiment, trouble tickets are generated for the responsible users based on the posted problems, and the trouble tickets are prioritized, ranked, or organized based on the severity of the problem to the organizational entity or to the project. The user responsible for solving the problem may send messages to the users who have indicated they are having the problem, asking the users for more information about how the problem was created. The user responsible for solving the problem may also post a solution, and select an option for the solution to be sent to all users who have indicated that they have the problem. In another embodiment, notification to a user who has the problem is automatic when a solution to the problem is posted. In one embodiment, users may adopt or certify posted problems and solutions as acceptable problems and solutions for the organizational entity. In one embodiment, a user posting a problem may mark the problem as closed when a solution that is acceptable to the user is posted for the problem. In one embodiment, the project management system organizes problems and solutions into a training manual or troubleshooting manual for the tool or technology that is the subject of the project. In another embodiment, in the course of troubleshooting the issue or responding to the problem, if an agent charges a third party or related party for the service and incurs an account receivable for the service provided, the system may make a note of the details surrounding the feedback item and the amount payable and produce such accounts payable in a separate spreadsheet or accessible via an API for accounting purposes.

In one embodiment, problem-type feedback items include problems and sub-problems, solutions, and sub-solutions, each of which may be separately rated. Sub-problems may be elements of a problem item, and sub-solutions may be elements of a solution item that is responsive to the problem. Sub-problems and sub-solutions may also be separated into new feedback items if there is sufficient activity regarding the sub-problems or sub-solutions, or if the topic of the sub-problems or sub-solutions diverges from the topic of the problems or solutions from which they originated. In one embodiment, users are presented with an option for creating a new feedback item out of an element of an existing feedback item.

### Recommending and Evaluating Actions

In one embodiment, the project management system allows users to select an option to search for or provide feedback of the type that recommends an action or evaluates a recommended action. A user may initially search for actions to see if the project management system includes a similar action. In one example, the user may search based on a goal, objective, predicted outcome, task, topic, or summary of the action. If the user finds the action in the project management system, the user may determine whether or not the action is likely to meet his or her goals. The action may indicate one or more steps to be taken by users to achieve the goal, objective, predicted outcome, or task. The actions may include any active step that could be performed by an agent. If the action is acceptable to the user, the user may exit the project management system and practice the action. The user may also provide feedback regarding the success of the action for the user, or the sentiment of the user towards the action. For example, the user may indicate that the user has the same goals, objectives, desired outcomes, or tasks and/or that the actions worked for the user in furtherance of these motivations. As another example, the user may like or dislike or rate the actions and/or feedback on the actions.

If the action has not been recommended, the user may use the project management system to add to an existing feedback item or add a new feedback item that describes the action in detail. For example, the user may describe one or more contextual properties or environment characteristics that explain the motivation for performing the action and contextual properties that describe how or in what context the actions are to be performed. The promotional text may include any tag line, descriptive name, motive, objective, motivation, goal, purpose, reason, or intent for performing or for avoiding the actions in the user-specified context. The contextual properties may include any detail that further defines or provides context for the action. For example, the contextual properties for an action item may include characteristics of an environment for performing the action, background properties, conditions, actors performing the action, objects of the action, tools used to perform the action, circumstances, characteristics which may influence ability to reproduce promoted outcome, variables or other factors predicted to affect the outcome. Users may also describe the importance of the actions and provide information about how the actions, if taken or if not taken, may affect the project, the tool or technology, or performance metrics associated with the organizational entity, such as profitability of the organizational entity. The user may also invite other users to try the actions and propose modifications to the recommended actions. For example, the user may share the actions with his or her team of engineers. As another example, the user may share the actions with agents of a different department. For example, the user may share the actions with a group of agents who are typically responsible for tasks that are the subject of the actions.

In one example, a user proposes an action of “Using a CRM mobile application to enter in customer information upon initial meeting and follow-up with requested information immediately after the initial meeting”. Users can rate whether the action worked for them, can add a department or goal to which the action is related, can ask for more information about the action or contextual properties that describe how or in what context the action is to be performed, or forward the action to other users.

If another user is invited to evaluate the action, the other user may see in the project management system how many users have viewed the action, how many users have attempted the action, and a percentage of the users for which the action worked to achieve a stated motivation. Such information may be indicative of the importance of the action to the organizational entity or to the project. In one embodiment, task lists are generated for the responsible users based on the posted actions, and the task lists are prioritized, ranked, or organized based on the importance of the action to the organizational entity or to the project. The user responsible for performing the task may send messages to the users who have suggested actions that can be performed to accomplish the task, asking the users for more information about how or in what context the actions are to be performed. The user responsible for the task may also post an outcome of performing the actions in a same or different context than the context specified in the action item. The responsible user may also select an option for the posted outcome to be sent to all users who are responsible for the task, or who have indicated an interest in the motivation or action. In another embodiment, notification to a user who is responsible for the task is automatic when an action supporting performance of the task is posted. In one embodiment, a user may mark the action as completed if the user has successfully completed the action. In one embodiment, users may adopt or certify posted actions after the users have tried the actions in furtherance of the motivation stated for the action. In one embodiment, the project management system organizes action lists into a training manual for the tool or technology that is the subject of the project.

In one embodiment, the action item specifies a task, and the actions specify actions that should be avoided when attempting the task. For example, the user may create an action item to share a practice that was not successful. Sharing unsuccessful practices encourages other employees to develop alternative practices and also saves other employees from independently realizing that the practice is unsuccessful.

In various embodiments, the feedback item may also indicate, as specified by the user input that defines the feedback item, an estimated amount of resources that would be used to perform the user-specified actions in the user-specified context. Examples of estimated amounts of resources may include, but are not limited to: an estimated amount of time used by the agents to perform the user-specified actions in the user-specified context, an estimated amount of money spent by the organizational entity to perform the user-specified actions in the user-specified context, an estimated amount of energy used by the agents to perform the user-specified actions in the user-specified context, an estimated amount of agent specialty of the agents that are qualified to perform the user-specified actions in the user-specified context, or an estimated amount of risk taken by the organizational entity if the agents perform the user-specified actions in the user-specified context.

The feedback item may also indicate, as specified by the user input that defines the feedback item, whether or not the user-specified actions had been performed by the agent in the user-specified context and in furtherance of a user-specified purpose for the ratable feedback item. Feedback items that have not yet been attempted may be referred to as hypothetical feedback items, and feedback items that have already been attempted may be referred to as tested feedback items.

The feedback item may also indicate, as specified by the user input, a limit on the user-specified actions. Examples of limits may include, but are not limited to: a time limit on particular action(s) of the user-specified actions, a monetary limit on particular action(s) of the user-specified actions, an energy limit on particular action(s) of the user-specified actions, a limit on an amount of agent specialty that can be used on particular action(s) of the user-specified actions, or a limit on an amount of risk that can be taken by the organizational entity for particular action(s) of the user-specified actions.

In one example, the feedback item includes two sets of user-specified actions. In one embodiment, the feedback item may also include a user-specified ordering limit on the first set of actions relative to the second set of actions. For example, the feedback item may indicate, as specified by the user input, that the first set of actions should be performed after the second set of actions, or that the first set of actions should be performed after the second set of actions. In another embodiment, the feedback item may indicate, as specified by the user input, that the first set of actions is an alternative to the second set of actions.

An existing feedback item may be rated by the agent(s) that created or modified the item or by different agent(s). In one embodiment, interface logic of the project management system causes display, to an agent via a user interface, of existing ratable feedback item(s). The user interface allows the agent to specify a rating for a selected existing ratable feedback item. For example, the existing ratable feedback item may include user-specified actions, user-specified contextual properties, and user-specified promotional text. In one embodiment, the rating describes a particular result of particular agent(s) performing the user-specified action(s) according to the user-specified contextual properties that define the feedback item. The rating is stored in association with the selected ratable feedback item.

In one embodiment, the rating indicates whether or not the user-specified goals, predicted outcomes, tasks, or other promotional text accurately promoted performance of the user-specified action according to the user-specified context. In a particular embodiment, the rating indicates whether or not the particular result satisfied a user-specified purpose for the feedback item. In another embodiment, the rating indicates a quantified effectiveness of the user-specified actions at supporting the user-specified purpose. In yet another embodiment, the rating indicates a sentiment of the particular agents regarding the particular result or the user-specified actions as performed by the particular agents.

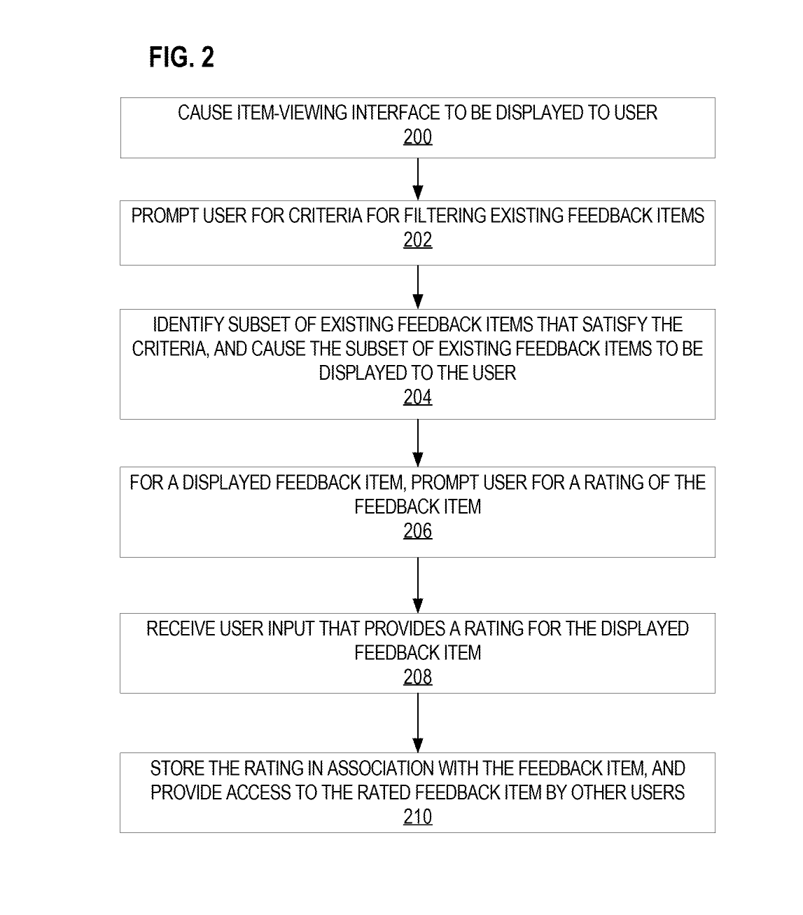

FIG. 2 illustrates an example process for evaluating feedback items. As shown, the process includes, in step 200, causing a user interface to be displayed to a user. In step 202, the project management system prompts the user for criteria to filter existing feedback items. The project management system identifies a subset of existing feedback items that satisfy the criteria, and causes the subset of existing feedback items to be displayed to the user in step 204. For example, the project management system may cause display of items of a specified type. For a displayed feedback item, the project management system prompts the user for a rating of the feedback item in step 206. The project management system receives user input that provides a rating for the displayed feedback item in step 208, and the rating is stored in step 210. Storing the rating may allow other users to access the rated feedback item. For example, the rating may be stored on a server that is accessible by a plurality of client applications in use by a plurality of users.

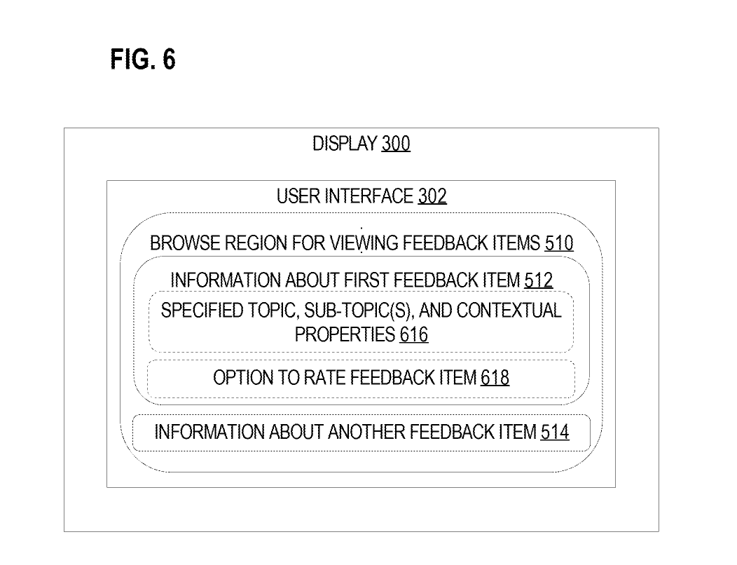

FIG. 6 illustrates an example interface for rating a feedback item. Within the information about a feedback item 512, interface 302 may display specified topic, sub-topic(s), and contextual properties of the feedback item 616 and also an option to rate the feedback item 618. In another embodiment, the option to rate is provided for each element of the feedback item alternatively or in addition to an option to rate the feedback item as a whole.

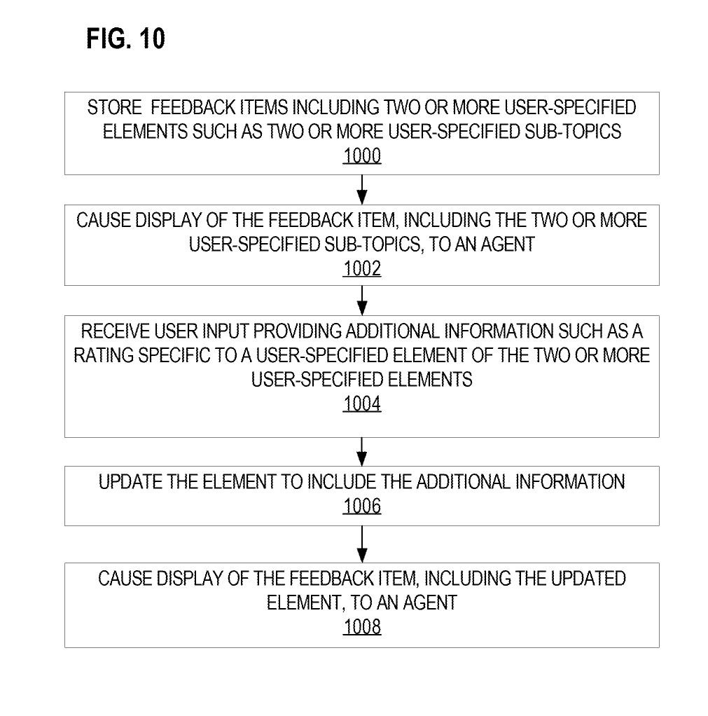

FIG. 10 illustrates an example process for receiving user feedback with respect to an individual element of a feedback item. In step 1000, the process includes storing feedback items including two or more user-specified elements such as two or more user-specified sub-topics. Display of the feedback item, including the two or more user-specified sub-topics, is caused in step 1002. The user provides input, in step 1004, specifying additional information such as a rating that is specific to a user-specified element of the two or more elements. The element is updated in storage to include the additional information in step 1006, and the feedback item including the updated element is displayed to an agent in step 1008. The agent may be the author of the update, the author of the feedback item, or another user with access to the feedback item.

In one embodiment, action-type feedback items include actions and sub-actions, each of which may be separately rated. Sub-actions may be elements of an action item, and sub-actions may be separated into new feedback items if there is sufficient activity regarding the sub-actions, or if the topic or goal of the sub-actions diverges from the topic or goal of the actions from which they originated. In one embodiment, users are presented with an option for creating a new feedback item out of an element of an existing feedback item.

### Asking and Evaluating Questions

In one embodiment, the project management system allows users to select an option to search for or provide feedback of the type that asks and answers questions. A user may initially search for questions to see if the project management system includes a similar question. In one example, the user searches based on a category, topic, or summary of the question. If the user finds the question in the project management system, the user may determine whether or not the question has been answered. The answer may indicate one or more steps to be applied by users asking the question. If the answer has been provided, the user may exit the project management system and apply the answer. The user may also provide feedback regarding the success of the answer for the user, or the sentiment of the user towards the answer. For example, the user may indicate that the user had the same question and/or that the answer resolved the question. As another example, the user may like or dislike or rate the question and/or the answer.

If the question has not been answered, the user may use the project management system to add to an existing feedback item or add a new feedback item that describes the question in detail. For example, the user may describe one or more contextual properties or environment characteristics that explain the environment or scenario to which the question applies. Users may also describe the importance of the question and provide information about how the unanswered question affects the project, the tool or technology, or performance metrics associated with the organizational entity, such as profitability of the organizational entity. The user may also invite other users to offer answers to the question. For example, the user may share the question with his or her team of engineers. As another example, the user may share the question with agents of a different department. For example, the user may share the question with a group of agents who are typically responsible for answering such questions, such as the IT department.

If another user is invited to answer the question, the other user may see in the project management system how many users have indicated that they have the same question and how many users have viewed the question. Such information may be indicative of the importance of the question to the organizational entity or to the project. In one embodiment, issue tickets are generated for the responsible users based on the posted questions, and the issue tickets are prioritized, ranked, or organized based on the importance of the question to the organizational entity or to the project. The user responsible for answering the question may send messages to the users who have indicated they have the same question, asking the users for more information about the environment or context to which the question applies. The user responsible for answering the question may also post an answer, and select an option for the answer to be sent to all users who have indicated that they have the same question. In another embodiment, notification to a user who has the same question is automatic when an answer to the question is posted. In one embodiment, users may adopt or certify posted questions and answers as useful questions and answers for the organizational entity. In one embodiment, a user posting an answer may mark the question as answered when an answer that is acceptable to the user is posted for the question. In one embodiment, the project management system organizes questions and answers into a training manual or troubleshooting manual for the tool or technology that is the subject of the project based upon author preferences or pre-determined algorithmic rankings (frequency of recurrence throughout organization, most viewed, etc).

In one embodiment, question-type feedback items include questions and sub-questions, answers, and sub-answers, each of which may be separately rated. Sub-questions may be elements of a question item, and sub-answers may be elements of an answer item that is responsive to the question. Sub-questions and sub-answers may also be separated into new feedback items if there is sufficient activity regarding the sub-questions or sub-answers, or if the topic of the sub-questions or sub-answers diverges from the topic of the questions or answers from which they originated. In one embodiment, users are presented with an option for creating a new feedback item out of an element of an existing feedback item.

### Recommending or Listing a Feature and Evaluating Features

In one embodiment, the project management system allows users to select an option to search for or provide feedback of the type that recommends new features or lists existing features. A user may initially search for recommended or listed features to see if the project management system includes a similar feature. In one example, the user searches based on a category, topic, or summary of the feature. If the user finds the feature in the project management system, the user may determine whether or not the feature has been adequately described or discussed. The description of the feature may indicate one or more useful properties of the feature to the project. For example, for a project to test a new computing device in a company, the features listed may include hardware features of the computing device such as ports, network cards, the display, the processor, or the storage device. The features listed may also include software features such as software installed on or compatible with and available to the device. Recommended features may include hardware or software that could be added to the device or used instead of the device, such as features that are missing, desired, or needing improvement. Each of the features may be described with enough detail for the reader to distinguish the hardware or software component from other hardware or software components, and/or with enough detail to provide interesting information about the component that is not readily available by a quick visual inspection. If the description has been provided, the user may exit the project management system and continue participation in the project with the additional knowledge provided by the description. The user may also provide feedback regarding the helpfulness of the description to the user, or the sentiment of the user towards the description. For example, the user may indicate that the user agrees with the description and/or that the description provided a useful detail about the feature to the user. As another example, the user may like or dislike or rate the feature and/or feedback about the feature.

If the feature has not been listed or described with sufficient detail, the user may use the project management system to add to an existing feedback item or add a new feedback item that describes the feature in detail. For example, the user may describe one or more characteristics that are unique to the feature within the tool and/or unique to the feature among several alternative tools. Users may also describe the importance of the feature and provide information about how the feature affects the project, the tool or technology, or performance metrics associated with the organizational entity, such as profitability of the organizational entity. The user may also invite other users to offer feedback or additional detail about the feature. For example, the user may share the feature with his or her team of engineers. As another example, the user may share the feature with agents of a different department. For example, the user may share the feature with a group of agents who are more familiar with the feature, such as a group of engineers.

If another user is invited to provide feedback or additional detail for the feature, the other user may see in the project management system how many users have provided feedback for or contributed detail to the feature and how many users have viewed the feature. Such information may be indicative of the importance of the feature to the organizational entity or to the project. The user providing additional information or feedback for the feature may send messages to the users who have indicated an interest in the feature. The user may post the feedback or additional details for the feature, and select an option for the additional information or feedback to be sent to all users who have indicated an interest in the feature. In another embodiment, notification to a user who has expressed interest in the feature is automatic when additional feedback or detail to the feature is posted. In one embodiment, users may adopt or certify posted features as useful features for the organizational entity. In one embodiment, a user requesting details for a feature may mark the feature as fully described when the additional details have been provided. In one embodiment, the project management system organizes features into a training manual or troubleshooting manual for the tool or technology to which the features are a part.

In one embodiment, feature-type feedback items include features and sub-features, each of which may be separately rated. Sub-features may be elements of a feature item. Sub-features may be separated into new feedback items if there is sufficient activity or detail regarding the sub-features, or if the topic of the sub-features diverges from the topic of the feature from which the sub-feature originated. In one embodiment, users are presented with an option for creating a new feedback item out of an element of an existing feedback item.

### Combining or Splitting Feedback Items

In one embodiment, users may develop a collection of feedback items by creating new feedback items for the collection or by using existing feedback items in the project management system. The user may indicate whether the new feedback item is a collection of feedback items or an individual feedback item, and the stored feedback item information may include information that indicates whether the information represents a collection of feedback items or an individual feedback item. User interface logic of the project management system may present, to a user via a user interface, an option to create a new feedback item or collection of feedback items. As with the option to create an individual feedback item, other options may be concurrently presented to the user along with the option to create a collection of feedback items. In one embodiment, an option to create an individual feedback item is presented to the user concurrently with an option to create a collection of feedback items.

Instead of relying on the user to input every element of a new collection, in one embodiment, the system allows a user to select individual feedback items on which the collection will be based. The system may provide a proposed initial selection for the user and allow the user to change the proposed initial selection. Alternatively, the system may allow the user to make the initial selection by selecting among the existing feedback items and creating new feedback items or placeholders for new feedback items that are to be included in a new collection. The placeholders may include empty or partially completed feedback items for which some of the topic information or contextual information is missing.

A new organizational process may include a collection of feedback items that includes new feedback item(s) and/or previously existing feedback item(s). The collection may include additional or modified topics, contextual properties, or other elements that are different from the topics, contextual properties, or other elements in the new or existing feedback items that are used to create the collection. The elements may be customized by the user after selecting the feedback items on which the new collection is based. Once created, a collection may be further customized by same or different users that access and modify the collection via the interface.

In one embodiment, the user interface includes draggable graphical elements for specifying an order of the feedback items in the collection. For example, a first graphical element representing a first feedback item is draggable to a position that is before or after a second graphical element representing a second feedback item. A user may drag the first graphical element from before the second graphical element to after the second graphical element to indicate that the first feedback item should be listed after the second feedback item rather than before the second feedback item. The ordering of feedback items may also be marked as locked or unlocked to indicate whether the positions are changeable and/or relevant or irrelevant to indicate whether the positions add meaning to the feedback item.

An example collection with three feedback items includes a first action item of verbally conveying a sales pitch to customers in a store with customers to help the store make a sale; a second action item of generating a report on a computer to help keep track of the sale; and a third action item of sending the report to a region manager via e-mail to help the store receive credit for the sale. The collection may have a collection-level, separate user-specified topic for improving a sales figure at a store. The collection-level topic may indicate why users should perform the three feedback items together; whereas, item-level motives for each feedback item indicate why users should perform each feedback item individually.

In one embodiment, collections of feedback items are imported from other users at the same or a different organizational entity. For example, a collection may be shared from one user to another user. The two users may be using a different instance of the project management system. Upon receipt of a collection from another user, the recipient may select a location within a hierarchy of feedback items in which to store the received collection.

The project management system may, optionally in response to user input, promote individual feedback items into collections of feedback items, and demote collections of feedback items into individual feedback items. In one embodiment, the project management system stores feedback items that include user-specified topic(s) and user-specified contextual detail(s). The project management system may combine two or more feedback items into a new collection of feedback items. The new collection of feedback items includes some or all of the contextual details specified by the two or more feedback items. The new collection also includes a topic that may or may not match any of the topics for the two or more feedback items that were combined in the collection. In one embodiment, the topic of the collection is different from at least one of the two or more feedback items that were combined in the collection. In a particular embodiment, the topic for the collection is a selected one of the topics from the two or more feedback items.

The new collection is stored as a new object in the project management system. In one embodiment, the two or more feedback items that were grouped into the collection may persist separately on a computer-readable storage medium, before, during, and after these feedback items are combined into the collection. The collection may be stored separately from the individual feedback items that were used to create the collection, and subsequent modification of the collection may or may not have any effect on the separately stored feedback items. Similarly, subsequent modification of the individual feedback items may or may not have any effect on the collection. In other words, the individual feedback items serve as a basis for creating the collection of feedback items, but the individual feedback items may remain independent of the collection.

In one embodiment, the project management system displays a collection of feedback items with indications that the individual feedback items have been combined into the collection of feedback items. For example, the organizational process may include a box around the items that make up the collection.

In one embodiment, promotion of individual feedback items into a collection is suggested automatically by the project management system. The project management system may identify popular, highly ranked, and related feedback items, such as feedback items with similar topics, in similar categories, or with similar contextual properties, and suggest, to a user, that these feedback items be combined to form a collection of feedback items. The project management system causes display, via a user interface, of a suggested combination of two or more feedback items, and provides the user with an option to modify the combination before creating the new collection. Modifying the combination may include adding or removing feedback items from the combination. In one embodiment, the user may accept the suggested combination with a single click on graphical element presented on the user interface.

In one embodiment, each of the two or more feedback items forming the new collection of feedback items may be associated with a rating. The new collection of feedback items may be assigned a predicted rating based on the ratings of the feedback items combined to form the new collection. For example, the rating of the new collection may be an aggregate, such as an average, a maximum, or a minimum, of the ratings of the two or more feedback items that form the collection.

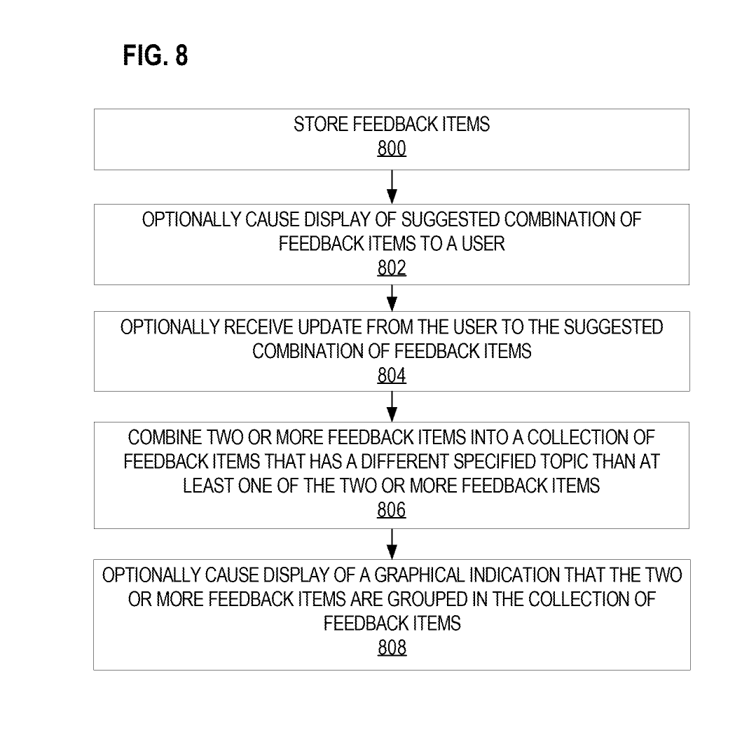

FIG. 8 illustrates an example process for combining feedback items into a collection of feedback items. In step 800, the project management system stores feedback items including topics and contextual properties. In step 802, the project management system optionally causes display of a suggested combination of feedback items to a user. In step 804, the project management system optionally receives a modification, by the user, of the suggested combination of feedback items. The project management system then combines two or more feedback items, such as the items in the suggested combination, into a collection of feedback items in step 806. The collection of feedback items may have a different topic than one or more of the combined feedback items. In response to a request to view the collection of feedback items, the project management system may cause display of a graphical indication that the two or more feedback items are grouped into the collection of feedback items, as provided in step 808.

In one embodiment, a collection of two or more feedback items may be demoted into two or more individual feedback items. The collection may have been modified to include feedback items that may be useful in other contexts, or for other collections of feedback items. The feedback items within the collection may be separately defined and made available for use in other collections of feedback items. In one example, the project management system provides an option to the user for exposing a feedback item within the collection for use in other collections.

### Creating a Project Summary

In one embodiment, the project management system creates a project summary based on the most popular, most viewed, most commented, most useful, highest-rated, and lowest-rated feedback items submitted for the project, as well as risk factors identified, present or realized. The project summary may be specific to a particular type of items or may include several different types of items. The project summary may also include charts and graphs that graphically display metrics associated with the project. For example, the charts and graphs may include a pie chart of the most popular uses for a new technology or the most popular features in a product. The project summary may be accessible to all agents or a sub-set of agents with certain privileges. For example, managers might have access to the project summary, but employees might not have access to the project summary. The process of FIG. 19 can generate such a project summary at, for example, steps 1918-1922. Multiple project summaries can be accessed and viewed concurrently by the system, providing a comparative view across multiple projects about popular features, satisfaction, goal achievement and other feedback item topics.

### Providing Feedback on the Pilot Project as a Whole

In one embodiment, a pilot project can be rated as a whole. A feedback item, such as a project sentiment, feedback, rating, or opinion, may be entered by agents. This type of feedback item is applied to the entire pilot project, as opposed to different aspects of the project as discussed elsewhere herein. Agents can thus provide a quick assessment of the entire project, which may result in a broad level of feedback that would otherwise not be captured.

The program management system can prompt for such feedback periodically, such as on a daily, hourly, or weekly basis. Such feedback can be anonymous, as discussed elsewhere herein.

A user interface for such project-level feedback can include a feedback interface element, such as a button or rating selector, at the bottom of each page of the pilot project user interface. An agent invoking this feedback interface element can immediately leave feedback, in the case of a star rating, or can be providing with another feedback interface element, such as a textbox, to leave comments.

### Preserving Anonymity of User-Generated Feedback Item Content

In one embodiment, feedback items and comments, ratings, or other feedback on feedback items may be provided anonymously, even while a user is logged into the project management system. The project management system may present, via the user interface, an option for submitting feedback item content or feedback content anonymously. If the option is selected for an item of content, then the content item appears anonymous to other users when viewed on the project management system. If the option is not selected for the item of content, then the item of content may be presented in association with the user who submitted the content item (the “author” of the content item). For example, the user interface may concurrently display the item of content with the author's name, picture, or other information about the author.

In a particular embodiment, whether or not the item is submitted anonymously, the project management system stores information that indicates the author submitted the anonymous content item. If the item is submitted anonymously, such information may be used to manage access or modification privileges, or notifications for the content item or activity related to the content item. For example, an author of a content item may be interested in whether any feedback or other updates are made with respect to the content item or related content items. The project management system may subscribe the author of the content item to such notifications even if the author elected to submit the content anonymously. Also, the project management system may indicate, to the author, that the author is the user who submitted the content item. When the author logs into the system or navigates to the content item, the project management system may indicate, to the author, that the content item belongs to the author, even if the author elected to submit the content item anonymously. The content item remains anonymous with respect to other users.

In one embodiment, the author may specify a first group of users to which the content item should remain anonymous, and/or a second group of users to which the content item need not remain anonymous. In this embodiment, the project management system may display the item of content in association with information about the author only to those users who are in the second group. The content item may be displayed anonymously to users in the first group.

In one embodiment, personal details, including name, job title, may be explicitly captured for anonymously submitted content, along with other features such as a number of years with the company, gender and other data that companies may select as data that is safe for analysis in an environment that preserves anonymity. These additional details about the author of the content may be used for analyzing results even though the content was submitted anonymously.

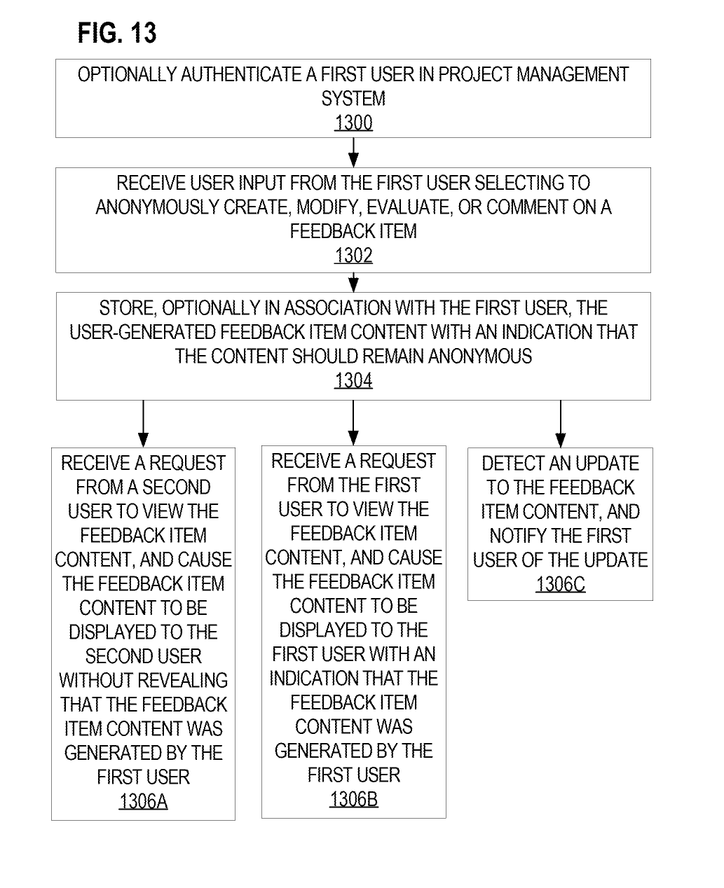

FIG. 13 illustrates an example process for preserving anonymity for feedback item content. As shown, the process includes optionally authenticating a first user in an project management system 1300. Input is received from the first user in step 1302. The input selects to anonymously create, modify, evaluate, or comment on a feedback item. In response to the input, in step 1304, the project management system stores the user-generated feedback item content with an indication that the content should remain anonymous. In one scenario, as reflected in step 1306A, a second user requests to view the feedback item content, and the feedback item content is displayed to the second user without revealing that the feedback item content was generated by the first user. In another scenario, as reflected in step 1306B, a further request is received from the first user to view the feedback item content. In response, the feedback item content is displayed to the first user with the indication that the feedback item content was generated by the first user. In a third scenario, as reflected in step 1306C, an update is detected for the feedback item, and the first user is notified of the update.

### Controlling Access or Modification to Feedback Items

In one embodiment, different users have different access or modification privileges with respect to different feedback items in the system. An author of feedback item content, whether the content is a new feedback item, an update to a feedback item, or feedback regarding a feedback item, may set privileges with respect to what other users are allowed to see the feedback item content. The privileges may allow some users to see some elements of the feedback item content but not other elements of the feedback item content. For example, the author may allow all users to see the topic of a feedback item, but only a subset of users to see the contextual properties and other details of the feedback item. The author may also decide whether or not the feedback item content should appear anonymous to other users. The author may set privileges such that the author is the only authorized viewer of the feedback item. These types of feedback items are said to be personal to the author. In various other examples, the author may share feedback items throughout one or more offices, departments, corporations, or other organizational entities, to a specified group of individuals, to a specific individual, to a corporate partner, to individual(s) outside the organization, or to supply chain individual(s).

In addition to specifying different privileges with respect to different elements of the feedback item, the author may also specify different types of privileges for different users. For example, a first group of users may be allowed to access and modify the feedback item without approval from the author, a second group of users may be allowed to access the feedback item and modify the action only if the author approves of the modification, a third group of users may be allowed to access the feedback item but not modify the feedback item, a fourth group of users may be allowed to access only a subset of the elements of the feedback item but not modify the feedback item, and a fifth group may not be allowed to access the feedback item. Different groups and different privileges may be appropriate in different scenarios.

In one embodiment, activity taken on feedback items may include changing the elements of the feedback item, such as changing the topic or the contextual properties specified by the feedback item. Other activity may include merging two feedback items together, splitting one feedback item into two feedback items, creating a separate child feedback item from an element of a feedback item, creating an element of a feedback item from a child feedback item, linking one feedback item to another feedback item with a unidirectional or bidirectional link, copying feedback items, instantiating feedback items into projects, commenting on, rating, or providing other feedback for the feedback item, or changing the privileges or other security properties of a feedback item.

In one embodiment, users are limited with respect to the amount of activity they can perform on the project management system within a given period of time. These limits may be based on the privilege level of the user—administrators may have few limits or no limits at all, standard users may have reasonable limits, and guest users or temporary users may have several limits. For example, users may be allowed to make only a certain number of deletions or modifications in a day. Such a limitation may prevent users from destroying valuable data or unreasonably controlling the data in the project management system.

In one embodiment, users may be limited with respect to printing, copying, or disseminating feedback items to other users. For example, the project management system may enter a display-only mode when displaying a protected feedback item. In the display-only mode, the project management system prevents the machine from printing, copying, or taking a screenshot of the feedback item information displayed on the screen. In a further example, the project management system may allow some information, such as the topic, contextual properties, and/or additional details for individual feedback items to be displayed only when the system is in display-only mode. Protected information may be hidden or masked. In response to a request from a user to view further information about the protected feedback item, the system may transition to display-only mode.

### Proposing Modifications or Deletions of Feedback Items

The project management system allows users to modify or propose modifications to feedback items in the system. In one embodiment, users that contributed to the feedback item are notified when a user requests to modify the feedback item in the project management system. Modifications to the feedback item may be marked on the feedback item when a request has been made to modify the feedback item. The marked modifications may be accepted and become a part of the feedback item whenever the author of the feedback item or a user with sufficient privileges confirms that the feedback item may be modified. The marked changes may also be further modified or rejected by a privileged user. In one embodiment, before the marked changes have been accepted or further modified, the project management system may display, to other users, a graphical indication that the feedback item has been marked for modification. The specific modifications may be marked in a tracked changes manner to the item that is displayed. The graphical indication may be anonymous or may identify the user that marked the changes on the feedback item. In one embodiment, multiple users may mark different modifications to the feedback item, and the different graphical indication may distinguish the different markings with color. If multiple changes are made, the latest marked changes may be marked as a modification to the previously marked changes or as a modification to the feedback item as it currently exists without the previously marked changes. In one embodiment, approval from a threshold percentage of users is requested and received prior to modification of the feedback item. Further approval may not be required when the author of the feedback item requests modification.

The project management system also allows a user to delete feedback items from the system. In one embodiment, users that contributed to the feedback item are notified when a user requests to remove the feedback item from the project management system. The feedback item is marked for removal and is deleted when the author or when a user with sufficient privileges confirms that the feedback item may be deleted. In one embodiment, before the marked removal has been approved, the project management system may display, to other users, a graphical indication that the feedback item has been marked for removal. The graphical indication may be anonymous or may identify the user that marked the feedback item for removal. In one embodiment, approval from a threshold percentage of users is also requested and received prior to deletion of the feedback item. Further approval may not be required when the author of the feedback item requests deletion.

### Certifying, Adopting, or Approving Feedback Items

In one embodiment, the project management system stores information that defines certification, adoption, or approval groups. Each certification group may include one or more agents and may be associated with a group name, a group role, and/or a graphical element specific to the group. The different graphical elements may be different shapes and/or colors. When displaying a feedback item to a user, the project management system may also provide a graphical indication of which group(s) have certified the feedback item. In a particular example, an organizational entity may have an energy-efficiency group with one or more experts on energy-efficiency, a cost-effective group with one or more experts on cost-effectiveness, and a market-ready group with one or more experts on market-readiness. The energy-efficiency group may be associated with a green leaf icon, the cost-effective group with a gold coin icon, and the market-ready group with a gray icon showing a group of people. The certification icons allow a viewer of the feedback item to quickly identify the general acceptance of a feedback item in the organizational entity.

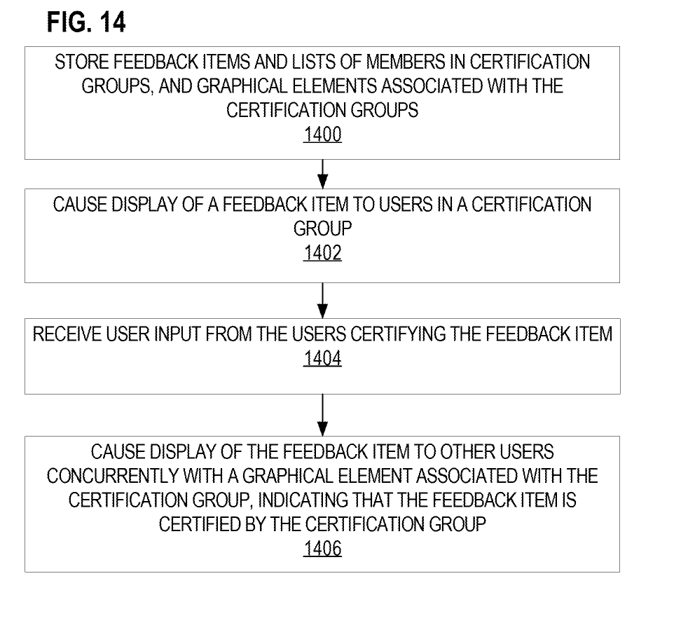

FIG. 14 illustrates an example process for managing certification of feedback items. In step 1400, lists of members in certification group and graphical elements associated with the certification groups are stored in addition to the feedback items. In step 1402, the feedback items are displayed to the members of the certification group. In step 1404, input is received from the members, certifying the feedback item for the group. In step 1406, the project management system causes display, to other users, of the feedback item concurrently with a graphical element associated with the certification group. Display of the graphical element next to the feedback item indicates that the feedback item was certified by the certification group.

Instantiating Feedback Items into Projects

In one embodiment, feedback item(s) may be instantiated into new projects that are associated with a particular instance of the feedback item(s) and exists independently of an existing project. The feedback items may persist in storage before, during, and after instantiation into a new project. The new project merely includes a copy or instance of the feedback items that is in use. In one embodiment, the new project is tied to particular date(s), particular location(s), particular agent(s), particular department(s), particular product(s), particular account(s), or particular object(s) for which the feedback items themselves are generic. For example, a feedback item that specifies how to troubleshoot an error on a machine may be generic with respect to the date and the machine, but the project based on the feedback item may be tied to a particular date, such as the date of a troubleshooting ticket, and/or tied to a particular machine, such as a customer's machine identified in the troubleshooting ticket.

Projects may transition to and from various states. For example, a project may be planned, pending, or completed. The agents taking part in the project may receive notifications as the project transitions from state to state, or as feedback or other content is received about the project. During the project or once the project is completed, the agents taking part in the project may provide ratings for the feedback items used during the project. The ratings for the project, whether by agents implementing the project or by users observing the project, may also be attributed to the feedback items on which the project is based.

### Subscribing and Unsubscribing to Feedback Items

In various embodiments, users may subscribe or unsubscribe to notifications about feedback items. The project management system may store, for each feedback item, a list of users that are subscribed to notifications for the feedback item, and the types of notifications for which the users are subscribed. For example, users may be subscribed to receive notifications when any activity occurs with respect to a collection of feedback items, an individual feedback item, or an individual element of a feedback item. As another example, the subscription may request notification only if specific types of activities occur with respect to the content item. A particular example subscription may request notification for modifications to the feedback item or ratings of the feedback item, but not for access to the feedback item or comments on the feedback item. Other users may desire notification about other types of activity, and the project management system may be tailored to meet the preferences of these users.

In one embodiment, a user may subscribe or unsubscribe to a project. The user may subscribe to the project after the project has been created in the system, possibly as a result of participating in the project. In one embodiment, a user subscribed to a feedback item is automatically subscribed to any projects that are created based on the feedback item. Users may specify whether they would like to be notified about derivative projects that stem from feedback items to which they are subscribed.

The notifications may be provided via any form of message or special emphasis to the user. For example, upon detecting that the subscribed activity has occurred, the project management system may e-mail the subscribers that specified a preference for e-mail communications, text the subscribers that specified a preference for text message communications, and/or place a notification on a home page for subscribers that specified a preference for notification within the project management system after logging into the project management system. Other users may have other preferences for notification, and the project management system may be tailored to meet the preferences of these users.

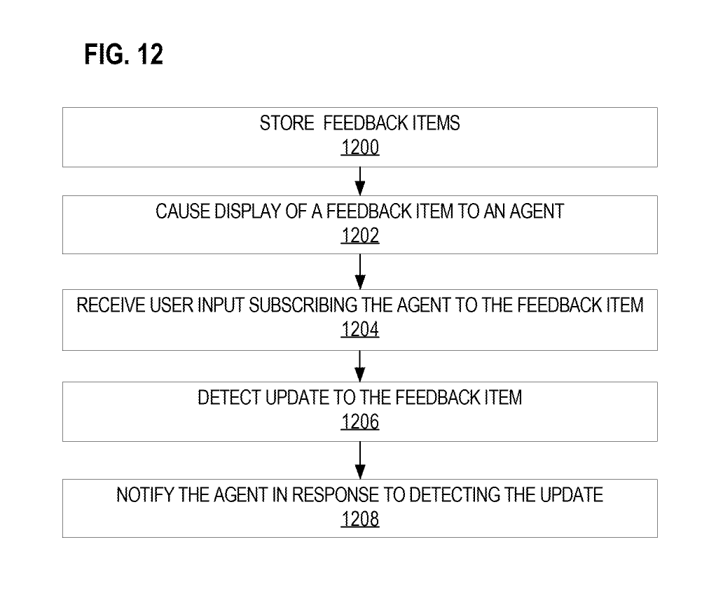

FIG. 12 illustrates an example process for notifying agents about updates to feedback items. Feedback items are stored in step 1200 and displayed to an agent in step 1202. User input is received in step 1204, subscribing the agent to a feedback item. For example, the agent may be subscribed by default upon creating, modifying, or commenting on a feedback item. As another example, the agent may explicitly select an option, displayed concurrently with the feedback item, to subscribe or unsubscribe to the feedback item. The project management system detects an update to the feedback item in step 1206. In response to detecting the update, either immediately or periodically, the project management system notifies the agent of the update in step 1208. For example, the project management system sends a message to the agent or places a notice on the homepage or news feed of the agent.

### Importing or Linking Documents or Media to Feedback Items

The project management system may store document content and media content within feedback items or linked to feedback items. In one example, the feedback item, document content, and media content are stored in the same location on disk, managed as a single object. In another example, the feedback item references document content or media content. The document content or media content may be stored locally in a referenced folder or over the network at a referenced network address. Regardless of where the document content or media content is stored, these contents may be displayed on the user interface concurrently with the feedback item, or in response to selection by a user of an option to view document(s) or media item(s) associated with the feedback item. The option may be displayed concurrently with the feedback item.

Document content or media content may be associated with feedback items not only to describe the elements of the feedback items, such as the topics or contextual properties, but also as part of the feedback on the feedback items. In one example, feedback may be provided in the form of a video or audio file. The video or audio file may be stored in the feedback item or referenced by the feedback item.

### Rewarding Users for Generating Content

In one embodiment, the project management system manages rewards that are granted to users for generating feedback item content or feedback content. Users may specify rewards to be granted based on certain criteria. Rewards may be granted in terms of money or virtual currency. In one embodiment, rewards are granted to users who generate feedback items that are viewed, attempted, rated, commented on, modified, certified, or adopted above a threshold number of times. Users may alternately be rewarded for generating new feedback items or feedback items that are sufficiently different from existing feedback items. In yet another embodiment, users may be rewarded for responding to a request to generate feedback item content.

### Licensing and Exchanging Feedback Items

In one embodiment, feedback items are stored in association with an owner. The owner may license, exchange, or sell his feedback items or access to his feedback items. Customers may license, exchange, or purchase not only the feedback items or access to the feedback items, but also patent rights, deliverables, other property rights associated with the feedback items. The owner may receive credit for the sale in the form of other feedback items, money, or virtual currency that exists within the project management system. The virtual currency may be exchanged for money or for other feedback items.

In one embodiment, the project management system displays feedback items to potential buyers. For a collection of feedback items, the system may present promotional text or summary information and hide or mask other, more sensitive, information. In one embodiment, patent number(s), patent application number(s), product number(s), and other property identifiers are stored in association with content items and optionally displayed in association with the feedback items. A collection of feedback items may be purged of personal identification information, anonymized, or otherwise aggregated before being made available for sale or license.

In response to receiving a request to purchase a feedback item or access to the feedback item, the project management system may credit the seller of the feedback item or the access to the feedback item. The project management system may also provide the buyer with access to the feedback item.

FIG. 15 illustrates an example process for selling feedback items. A collection of feedback items is stored in step 1500, optionally in association with an owner of the collection. In step 1502, the project management system causes display, to a customer, of a user-specified topic for the collection of feedback items. The user-specified topic does not identify one or more feedback items or one or more elements of one or more feedback items within the collection of feedback items. Such information may be hidden from or masked to the customer. In step 1504, the project management system receives input, from the customer, requesting purchase of access to the collection of feedback items from the owner. In step 1506, in response to the request, the project management system causes a debit or charge to the customer and a credit or payment to the owner. In step 1508, the project management system grants the customer access to the collection of feedback items. Having purchased the access, the customer may view the hidden or masked feedback items or elements of feedback items in the collection of feedback items.

Learning Ratings from Similar Feedback Items

In one embodiment, the project management system predicts ratings for similar feedback items, for feedback items in similar feedback item hierarchies, or for feedback items in similar categories. In one example, a feedback item may be used in two different departments. The feedback item may be heavily rated by the first department and lightly rated by the second department. The project management system may present, to users viewing the feedback item for the second department, a predicted rating based on how users have reacted to the feedback item in the first department. The predicted rating may be provided even if the feedback item has not yet been used by the second department. Predicted ratings may be adjusted when the ratings from the first department change, or overridden by subsequent ratings provided for the second department.

In another example, feedback items that are similarly positioned within a hierarchy of similar feedback items may receive a predicted rating based on other feedback items in the similar position of a similar hierarchy. In yet another example, feedback items in similar categories may receive similar ratings. Ratings may also be predicted based on the author of the feedback item. For example, authors who frequently submit highly rated feedback items may receive high predicted ratings for newly authored feedback items.

General ratings for a collection of feedback items, a feedback item, or an element of a feedback item may be predicted based on characteristics about the author, such as the author's age, years with company, gender, position, title, and/or the rating, success, or popularity of content previously generated by the author. Ratings may also be user-specific. For example, the project management system may predict that a feedback item is appropriate for a first user who is technologically savvy but not for a second user who is not technologically savvy. When the first user is interacting with the project management system, the first user may see a high predicted rating for a feedback item that involves a high level of exposure to technology. The second user may see a low predicted rating for the same item, but a higher rating for an item that involves a lower level of exposure to technology. In this manner, the rating may change from user to user based on the skills, expertise, background, and personality of the user.

### Suggesting New Feedback Items or New Elements of Feedback Items

In one embodiment, new feedback items or new elements of feedback items are suggested for a first hierarchy of feedback items when the first hierarchy of feedback items has many but not all of the same feedback items as a second hierarchy of feedback items. For example, similar hierarchies may be developed by different departments in parallel, and suggestions may be made to one department based on well-rated feedback items in the hierarchy of the other department. Similarly, feedback items with similar topics or contextual properties may be predicted to have other similar elements. The project management system may suggest elements in one feedback item with a topic when the elements are included in another feedback item with a similar topic. Suggested feedback items or elements of feedback items may be accepted by the user with a single click or modified as the user sees fit.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

For example, FIG. 16 is a block diagram that illustrates a computer system 1600 upon which embodiments of the disclosure may be implemented. A computer system 1600 may be used by a user or agent to work with pilot projects, as discussed above. Computer system 1600 includes a bus 1602 or other communication mechanism for communicating information, and a hardware processor 1604 coupled with bus 1602 for processing information. Hardware processor 1604 may be, for example, a general purpose microprocessor.

Computer system 1600 also includes a main memory 1606, such as a random access memory (RAM) or other dynamic storage device, coupled to bus 1602 for storing information and instructions to be executed by processor 1604. Main memory 1606 also may be used for storing temporary variables or other intermediate information during execution of instructions to be executed by processor 1604. Such instructions, when stored in non-transitory storage media accessible to processor 1604, render computer system 1600 into a special-purpose machine that is customized to perform the operations specified in the instructions.

Computer system 1600 further includes a read only memory (ROM) 1608 or other static storage device coupled to bus 1602 for storing static information and instructions for processor 1604. A storage device 1610, such as a magnetic disk or optical disk, is provided and coupled to bus 1602 for storing information and instructions.

Computer system 1600 may be coupled via bus 1602 to a display 1612, such as a liquid-crystal display (LCD) or light-emitting diode (LED) display, for displaying information to a computer user. An input device 1614, including alphanumeric and other keys, is coupled to bus 1602 for communicating information and command selections to processor 1604. Another type of user input device is a cursor control device 1616, such as a mouse, a trackball, or cursor direction keys for communicating direction information and command selections to processor 1604 and for controlling cursor movement on display 1612. This input device typically has two degrees of freedom in two axes, a first axis (e.g., x) and a second axis (e.g., y), that allows the device to specify positions in a plane. One or more of the input device 1614 and cursor control device 1616 can include a touch-sensitive device of the display 1612 (i.e., touch-screen).

Computer system 1600 may implement the techniques described herein using customized hard-wired logic, one or more ASICs or FPGAs, firmware and/or program logic which in combination with the computer system causes or programs computer system 1600 to be a special-purpose machine. According to one embodiment, the techniques herein are performed by computer system 1600 in response to processor 1604 executing one or more sequences of one or more instructions contained in main memory 1606. Such instructions may be read into main memory 1606 from another storage medium, such as storage device 1610. Execution of the sequences of instructions contained in main memory 1606 causes processor 1604 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 1610. Volatile media includes dynamic memory, such as main memory 1606. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 1602. Transmission media can also take the form of acoustic or light waves, such as those generated during radio-wave and infra-red data communications.

Various forms of media may be involved in carrying one or more sequences of one or more instructions to processor 1604 for execution. For example, the instructions may initially be carried on a magnetic disk or solid state drive of a remote computer. The remote computer can load the instructions into its dynamic memory and send the instructions over a telephone line using a modem. A modem local to computer system 1600 can receive the data on the telephone line and use an infra-red transmitter to convert the data to an infra-red signal. An infra-red detector can receive the data carried in the infra-red signal and appropriate circuitry can place the data on bus 1602. Bus 1602 carries the data to main memory 1606, from which processor 1604 retrieves and executes the instructions. The instructions received by main memory 1606 may optionally be stored on storage device 1610 either before or after execution by processor 1604.

Computer system 1600 also includes a communication interface 1618 coupled to bus 1602. Communication interface 1618 provides a two-way data communication coupling to a network link 1620 that is connected to a local network 1622. For example, communication interface 1618 may be an integrated services digital network (ISDN) card, cable modem, satellite modem, or a modem to provide a data communication connection to a corresponding type of telephone line. As another example, communication interface 1618 may be a local area network (LAN) adaptor to provide a data communication connection to a compatible LAN. Wireless links may also be implemented. In any such implementation, communication interface 1618 sends and receives electrical, electromagnetic or optical signals that carry digital data streams representing various types of information.

Network link 1620 typically provides data communication through one or more networks to other data devices. For example, network link 1620 may provide a connection through local network 1622 to a host computer 1624 or to data equipment operated by an Internet Service Provider (ISP) 1626. ISP 1626 in turn provides data communication services through the world wide packet data communication network commonly referred to as the Internet 1628. Local network 1622 and Internet 1628 both use electrical, electromagnetic or optical signals that carry digital data streams. The signals through the various networks and the signals on network link 1620 and through communication interface 1618, which carry the digital data to and from computer system 1600, are example forms of transmission media.

Computer system 1600 can send and receive information through the network(s) 1622-1628, network link 1620, and communication interface 1618.

In one embodiment, one or more servers 1630 perform all of or a portion of the processes describe herein and communicate information regarding the processes to the computer system 1600 through the Internet 1628, ISP 1626, local network 1622, and communication interface 1618. The computer system 1600 renders one or more of the user interfaces described herein to allow input and output of information regarding the processes. The one or more servers 1630 may be accessible to a wide variety of computer systems 1600, including those used by different organizations. The one or more servers 1630 can each be a computer system that has substantially the same components as the computer system 1600, and the above description of the computer system 1600 can be referenced. Each of the one or more servers 1630 can omit a display 1612, an input device 1614, or a cursor control device 1616. In performing the processes described herein and communicating with remote computer systems 1600, the one or more servers 1630 may provide what is known as software as a service (SaaS) or a cloud-based application.

In another embodiment, one or more servers 1630 are located from a network perspective with host 1624 and are thus limited to access only by computer systems 1600 authorized to access the local network 1622. Local network 1622 or host 1624 may include a firewall to limit access to the local network 1622. This embodiment may be used by an organization implementing the techniques described herein as an internal tool.

In the foregoing specification, embodiments of the disclosure have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. A process for displaying and creating feedback of a pilot project, the process comprising:
one or more computing devices storing a plurality of feedback items specified by a plurality of agents, each feedback item of the plurality of feedback items being associated with an agent of the plurality of agents of a pilot project, each feedback item having a specified type of feedback of a plurality of different types of feedback;
the one or more computing devices causing display, to a particular agent of the organizational entity, of:
a first option of two or more options corresponding to a first type of feedback on the pilot project; and
a second option of the two or more options corresponding to a second type of feedback on the pilot project;
the one or more computing devices receiving, from the particular agent, a selection of one or more of the first option and the second option; and
in response to the selection, causing display, to the particular agent, of:
if the first option is selected, a first set of feedback items of the first type, and a third option to create a first feedback item of the first type; and
if the second option is selected, a second set of feedback items of the second type, and a fourth option to create a second feedback item of the second type.

2. The process of claim 1, further comprising the one or more computing devices causing display, to the particular agent, of an ending time for a current phase of the pilot project.

3. The process of claim 1, wherein the selection is a first selection, the process further comprising:
the one or more computing devices receiving, from the particular agent, a second selection of the third option and, in response, causing display, to the particular agent, of a fifth option for creating the first feedback item anonymously;
if the fifth option is not selected for the first feedback item, the one or more computing devices storing a public association between the first feedback item and the particular agent, wherein the public association is accessible to one or more other agents of the plurality of agents; and
if the fifth option is selected for the first feedback item, the one or more computing devices not storing the public association between the first feedback item and the particular agent.

4. The process of claim 1, wherein the first option is an option to report a problem for the pilot project or view reported problems for the pilot project.

5. The process of claim 1, wherein the first option is an option to recommend an action for the pilot project or view recommended actions for the pilot project.

6. The process of claim 1, wherein the first option is an option to ask a question related to the pilot project or view asked questions related to the pilot project.

7. The process of claim 1, wherein the first option is an option to rate a feature of the pilot project or view rated features for the pilot project.

8. The process of claim 1, wherein the first option is an option to indicate a risk of the pilot project or view risks of the pilot project.

9. The process of claim 1, wherein the first option is an option to recommend a feature for the pilot project or view recommended features for the pilot project.

10. The process of claim 1, wherein the first option is one of:
an option to report a problem for the pilot project or view reported problems for the pilot project;
an option to recommend an action for the pilot project or view recommended actions for the pilot project;
an option to ask a question related to the pilot project or view asked questions related to the pilot project;
an option to recommend a feature for the pilot project or view recommended features for the pilot project;
an option to rate a feature of the pilot project or view rated features for the pilot project; and
an option to indicate a risk of the pilot project or view risks of the pilot project; and
wherein the second option is a different one of:
an option to report a problem for the pilot project or view reported problems for the pilot project;
an option to recommend an action for the pilot project or view recommended actions for the pilot project;
an option to ask a question related to the pilot project or view asked questions related to the pilot project;
an option to recommend a feature for the pilot project or view recommended features for the pilot project;
an option to rate a feature of the pilot project or view rated features for the pilot project; and
an option to indicate a risk of the pilot project or view risks of the pilot project.

11. The process of claim 1, wherein the selection selects the first option, the process further comprising, in response to the selection, the one or more computing devices causing display, to the particular agent, of:
for each feedback item of the first set of feedback items, an option to rate the feedback item.

12. The process of claim 1, wherein the selection selects the first option, the process further comprising, in response to the selection, the one or more computing devices causing display, to the particular agent, of:
for a feedback item of the first set of feedback items, a rating of the feedback item that indicates a utility of the feedback item to agents of the plurality of agents.

13. The process of claim 1, wherein the selection selects the first option, the process further comprising, in response to the selection, the one or more computing devices determining the first set of feedback items from a plurality of feedback items of the first type, wherein the particular agent is authorized to access the first set of feedback items but not a second set of feedback items of the plurality of feedback items.

14. The process of claim 1, wherein the selection selects the first option, the process further comprising:
the one or more computing devices receiving a request from the particular agent to subscribe to a particular feedback item of the first set of feedback items;
the one or more computing devices detecting an update to the particular feedback item; and
in response to detecting the update, the one or more computing devices notifying the particular agent of the update.

15. The process of claim 1, further comprising the one or more computing devices causing display, to the particular agent, of a first graphical element associated with the first option and a second graphical element associated with the second option.

16. One or more non-transitory computer-readable media storing instructions which, when executed by one or more computing devices, cause the one or more computing devices to perform the process recited in claim 1.

17. A process for performing a time-limited pilot project, the process comprising:
receiving at one or more servers a definition of a pilot project, the definition including at least a goal and at least one of an end time and a duration for the pilot project;
receiving at the one or more servers definitions of phases of a plurality of phases of the pilot project, the definitions of the phases including a duration of each phase;
after receiving the definition of the pilot project and the definitions of the phases of the pilot project, commencing the pilot project;
during each of the phases, the one or more servers communicating over a network with a plurality of agents to receive feedback of different types from agents of the plurality of agents and to display received feedback of different types to agents of the plurality of agents; and
ending the pilot project after a final phase of the plurality of phases.

18. The process of claim 17, further comprising the one or more servers automatically suggesting phases for the pilot project.

19. The process of claim 17, further comprising sending over the network reminders to agents of the plurality of agents, the reminders being configured according to a current phase of the pilot project.
